(19) United States
(12) Patent Application Publication
(10) Pub. No.: US 2015/0317882 A1
(43) Pub. Date: Nov. 5, 2015

(54) GAMES, METHODS OF PLAYING GAMES, AND SYSTEMS FOR DELIVERING GAMES

(71) Applicant: 21Pink Inc., Tortola (VG)

(72) Inventors: NG KIAN MING, Shanghai (CN); YANG YIH TZUEN, Shanghai (CN); CYRUS LINBERT LUM, Campbell, CA (US)

(21) Appl. No.: 14/644,060

(22) Filed: Mar. 10, 2015

Related U.S. Application Data
(60) Provisional application No. 61/950,637, filed on Mar. 10, 2014.
(60) Provisional application No. 61/975,537, filed on Apr. 4, 2014.
(60) Provisional application No. 61/975,551, filed on Apr. 4, 2014.

(51) Int. Cl. G07F 17/32

(52) U.S. Cl. CPC G07F 17/3293; G07F 17/3272; G07F 17/3225

(57) ABSTRACT

Games and method of playing games. In other embodiments, systems for delivering games electronically and/or for allowing games to be played remotely. In certain embodiments, single and multi-player electronic games where players participate in playing card play, where players are geographically located at locations remote or distant from a playing card dealer. In still other embodiments, unique playing card games and/or games with unique wager opportunities, casino style card games, or bingo type games.

### RELATED APPLICATION DATA

This application claims priority to U.S. Patent Application No. 61/950,637, similarly titled, and filed Mar. 10, 2014. This application also claims priority to U.S. Patent Application No. 61/975,537, similarly titled, and filed Apr. 4, 2014 and U.S. Patent Application No. 61/975,551, similarly titled, and filed Apr. 4, 2014. The entireties of such applications are each hereby incorporated by reference.

### FIELD OF INVENTION

This invention relates to games and method of playing games. In other embodiments, this invention relates to systems for delivering games electronically and/or for allowing games to be played remotely. In certain embodiments, this invention relates to single or multi-player electronic games where players participate in playing card play, where players are geographically located at locations remote or distant from a playing card dealer. In other embodiments, this invention relates to unique games and wagers played with playing cards or to casino style card games or to bingo type games.

### BACKGROUND OF THE INVENTION

Playing cards, and many of the games that may be played with them, have been known for centuries. In conventional, prior known playing card games, a deck of cards is utilized which typically contains fifty-two cards having various ranks and suits. Generally speaking, in many playing card games, a set number of playing cards is dealt to players at a table by a dealer, and, regardless of the intervening rules of the particular game, winners of the game are often determined according to the best ranking hands, as calculated by examining the individual ranks and suits of each player's hand of cards, both alone or combined together (e.g., such as to form pairs, or straights or flushes).

While certain games, such as poker, have been popular in the United States for more than a century, during recent times, a particular variant of poker called Texas Hold'em has surged in popularity. This popularity is believed to be due, at least in part, to Texas Hold'em's significant exposure in televised poker games, often involving high stakes (e.g., such as in no limit games) or celebrities, as well as due to its presence in movies and literature and its existence in pure electronic form on the internet.

Certain forms of poker have, in the past, been offered in electronic versions on the internet, often involving computer generated playing cards generated and dealt by a computer in virtual, rather than real, physical form. That is, rather than real playing cards or a real dealer (i.e., a live person) being employed, conventional electronic poker has typically involved electronically generated images of playing cards which are “virtually” dealt by a computer executing software instructions. For this reason, it is not known to a player of such an electronic poker game whether the playing cards are being dealt properly (e.g., using the proper number of ranks and suits in a playing card deck), or whether the software which embodies the playing card game has been tampered with, hacked into, and/or was otherwise designed poorly and unfairly to begin with. For such reasons, although it may be acceptable to wager fake or virtual money with such electronic poker games, it has been viewed as risky in the prior art to wager real currency.

In view of the above drawbacks, it has been discovered by the Applicants for invention herein that there is a need for a system for providing playing card play, which can be played physically remote from a dealer, but with reduced or eliminated risk of cheating, computer hacking, or computer software error. It has also been discovered by Applicants that there is a desire for a new and unique poker variant which improves upon conventional Texas Hold'em. Delivery of other remote player games—where a live dealer is used, but players are geographically remote—such as other playing card games, bingo, or any other casino game (e.g., table game), have also been determined by Applicants to be desired. Head-to-head challenge matches where players are located remote from one another have also been determined by Applicants to be desirable.

It is, in certain embodiments, a purpose of the herein described inventions to address one or more of the above drawbacks or needs in the art. It is also a purpose of the herein described inventions to address other drawbacks and/or other desires for improvements in the art, whether or not currently known, which will become more apparent to the skilled artisan once given the present disclosure.

### SUMMARY OF CERTAIN EXAMPLES EMBODIMENTS OF THE INVENTION

Generally speaking, one or more of the inventions described herein involve unique playing card games, often including wagers, played with playing cards dealt by a playing card dealer. In at least one other invention described herein, a system is provided for delivering or providing playing card game play (or other game play types) in which game players need not be in the same geographical location as one or more playing card dealers. In some of such non-limiting embodiments, playing card games may be played by players located remote from a playing card dealer table, while otherwise viewing the playing card dealer table on a video or imaging monitor. Examples of such embodiments include systems in which game play is delivered to players utilizing a mobile device (such as a cellular phone or tablet type device), a desktop or laptop computer, a television, or a kiosk (e.g., such as located in an airport). In preferred embodiments, the systems deliver game play over networks, such as internet, satellite, television broadcast signal, radio frequency, or infrared data delivery networks. Of course, broadband or high data transfer rate delivery speeds are preferred, therefore, in typical embodiments, game play is delivered over high speed internet connections such as to laptop computers or tablets. In such embodiments, game play may be delivered in a stand alone user interface (e.g., including video graphics, a graphical user interface, and a physical controller device, and the like) or may be delivered hybridized to existing media or social outlets such as social networks like Facebook™ (e.g., a game may be delivered on a game-devoted/tailored Facebook page or on a page accessed via a social network such as Facebook).

In at least one example embodiment, there is provided: a system for providing game play, utilizing playing cards, comprising: a playing card dealer table outfitted or associated with one or more scanner or detector devices capable of scanning or detecting the rank and suit of playing cards dealt by a playing card dealer; one or more game player display screens configured for displaying game play data and information, said one or more game player display screens being located geographically remote from said playing card dealer table; one or more game player data input devices configured to permit one or more game players to input instructions, in the form of transmittable data, corresponding to game play decisions or actions, for transmission to said playing card dealer table or a processor or database associated with said playing card dealer table or to a game operator, said one or more game player data input devices being located geographically remote from said playing card dealer table; an image or video capturing device for capturing images or video of said playing card dealer table and a playing card dealer, said image or video capturing device further being configured for transmitting image or video data collected to said one or more game player display screens; a bi-directional network communicably connecting said player card dealer table, said one or more game player display screens, said one or more game player data input devices, and said image or video capturing device; said bi-directional network being configured to deliver or transmit data generated or transmitted by one or more game players, utilizing said one or more game player data input devices, or generated or transmitted by said playing card dealer table, or generated or transmitted by said one or more scanners or detector devices outfitted on or associated with said playing card dealer table, or generated or transmitted by said image or video capturing device; a game processor including a computer readable medium in communication with a computer processor; said computer readable medium and said computer processor being communicably connected to said bi-directional network; said computer readable medium including, stored thereon, a set of computer readable and executable instructions for processing by said computer processor, said computer readable and executable instructions being defined to control the parameters of playing card game play and being defined to direct data traffic on said bi-directional network, said data traffic resulting from data generated or transmitted by one or more game players, utilizing said one or more game player data input devices, or generated or transmitted by said playing card dealer table, or generated or transmitted by said one or more scanners or detector devices outfitted on or associated with said playing card dealer table, or generated or transmitted by said image or video capturing device, in conjunction with game play decisions or actions occurring during said playing card game play.

In at least one example game described herein, there is provided a game, deliverable with the systems described herein, comprising the following rules wherein: participating playing card game players place an opening ante wager in a designated location on said playing card dealer table; participating playing card game players optionally placing a progressive jackpot wager by placing a wager of a specified financial amount into a second designated location proximal said ante wager; participating playing card game players are dealt two playing cards on said playing card dealer table face-up, termed hole cards; after dealing said hole cards to the participating playing card game players, a dealer's hand is dealt on said playing card dealer table comprising two playing cards face-up; after said dealer's hand is dealt, participating playing card game players can choose a subsequent game play selected from the group consisting of: i) conceding and surrender said ante wager and ii) placing a first additional wager in a third designated location on said playing card dealer table, said additional wager being twice the value of said ante wager; after said subsequent game play is completed, three additional playing cards are dealt on said playing card dealer table face-up as community cards; after said three community cards are dealt, participating playing card game players can choose a subsequent game play selected from the group consisting of: iii) placing a second additional wager, said second additional wager being equal in value to said ante wager and iv) continuing game play without placing an additional wager; after all participating playing card game players have completed game play steps iii) or iv), a fourth community card is dealt face-up on said playing card dealer table; after said fourth community card is dealt, participating playing card game players can choose a subsequent game play selected from the group consisting of: v) placing a third optional wager, said second additional wager being equal in value to said ante wager and vi) continuing game play without placing an additional wager; after all participating playing card game players have completed game play steps v) or vi), a fifth community card is dealt face-up on said playing card dealer table; after said fifth community card is dealt, dealt hole cards of the participating playing card game players and dealt cards of said dealer's hand are separately compared to said five community playing cards, whereby a) each said two hole card set of the participating playing card game players is combined with three of said five community playing cards to obtain a best combination of rank and suits, termed said best player hand, as determined by poker rules; b) said two playing cards of said dealer's hand are combined with three of said five community playing cards to obtain a best combination of rank and suits, termed said best dealer hand, as determined by poker rules; and wherein said best player hands of the participating playing card game players are compared to the best dealer hand, and winning hands are determined according to a comparison of rank and value of best player hands as compared to the best dealer hand

In preferred embodiments of the invention (but still optional embodiments), real financial wager opportunities may provided with the systems described herein. In such embodiments, players of delivered games may establish financial accounts with the game provider or the game provided may allow access to game wager features by other financial account providers such as credit card providers, banks, pre-paid cards, Paypal accounts, or Bitcoin, for example. Of course, other mechanisms for permitting wagers may be permitted or provided.

In certain (but not all) embodiments, the invention is a method and/or system for cross-platform or multi-platform Texas Hold'em games. In certain embodiments, the platforms provide (or allow) a live, full screen video broadcast featuring a live dealer dealing real cards to be displayed on mobile, computer, internet, and/or other smart devices or displays. In certain of these embodiments, the users (which may include non-paying observers) and/or players may interact with displayed video content by manipulating an interactive user interface which is preferably overlaid on top of the video (but may optionally be provided side by side or elsewhere). In certain of these embodiments of the inventions, synchronizing technologies are provided to synchronize the video display with game play. In other words, the game play graphics and user/player interfaces (e.g., graphical user interfaces or GUIs) are synchronized with broadcast video. Example integrated game display configurations and/or system or network set-ups are shown in FIG. 15 for a card game and FIG. 16 for a bingo game.

In at least one embodiment of the inventions described herein, games are implemented using multiple software programs which communicate among one another, the software programs being encoded in readable memory devices, stored at a game provider location and separately at game player locations. In preferred examples of such embodiments, user/player installed applications (a.k.a. “apps”) are downloaded and/or deployed and/or utilized on mobile devices (e.g., smart phones), tablets, or personal computers. Such apps can also be installed in “Smart TVs” or in any other device capable of running HTML 5 or similar software (e.g., Adobe Flash). In certain embodiments described herein, the apps are preferably coded and/or configured to communicate with game provider software and/or hardware to allow a live dealer/game moderator to send information related to or comprising scanned playing cards, bingo balls, chips, or any other game objects presented during a game. In preferred embodiments, such information or data is broadcast simultaneously (or substantially simultaneously) to game players “running” or operating user or player apps on respective personal computing devices (e.g., again, whether mobile phones, computers, Smart TVs, or any other device). An example of how a broadcast may appear is depicted in FIG. 17. In most preferred embodiments (though not required), game broadcast, synchronizing, interaction, and/or game play happens in “real time”. That is, for example, a remote player can interact with a live game—using the herein described systems, methods, and software—in real time. As discussed elsewhere herein, such real time embodiments may include the use of a scanner (or detector) to scan (or detect) specially imprinted or embedded cards or game objects with barcodes or other identification codes or devices. See FIG. 18 for a depiction of an example game system configuration.

In certain embodiments of the inventions disclosed herein, alone or in combination with other embodiments, systems for multi-user group chats with a live game dealer are provided (e.g., using mobile chat technology). In examples of such embodiments, the provided chat or communication systems allow users, viewers, and/or players to chat in a group chat room directly with the live dealer allowing full complete interactive interaction between players and live dealer. See, e.g., FIG. 19. Methods for transmitting or communicating chat messages include (but are not limited to) text, voice or other audio, photos and images, and/or video. Using provided live chatting systems, the dealer can respond according to each key player. Preferred example live chatting systems include a central computer, known as a server, which will run server software for the purposes of enabling communication between the parties viewing or participating in the game.

Although not required for any embodiment, in certain examples of the inventions disclosed herein, a system of tipping or non-verbal communication is provided or utilized. For example, players may highlight, supplement, or enhance the text of a chat with an animated graphic that frames or draws attention to the chat message. Players may also give out tips in the form of emoticons which are optionally displayed to all the players participating in or viewing the game. This is, in some cases, the first time a player can actually highlight himself to the Live dealer or simply get the attention of the Live dealer (e.g., by adding or including a “tip” or “gift” in a message or messages). Different “tips”, of course, enable different highlights or enhancements to a message or to messages. See, e.g., FIGS. 20, 21, 22, and 23.

In certain (but not all) embodiments in which chatting (or tip or gift) functionalities are employed, a market or pricing system is optionally provided. For example, a pay-per-chat message is utilized in certain embodiments where the intended receiver of a chat message will be given an indication of the price of a message. Once the message is clicked on (e.g., after the user or player views pricing information), credits will be subtracted from the user or player's credit account and the message will be displayed. See, e.g., FIG. 24.

In still further alternative embodiments of the inventions disclosed herein, head-to-head or challenge based games or options are optionally provided. For example, in certain of such embodiments, a software “app” may be made accessible to users or players (or may be made available as an optional feature or update) which allows potential game players to challenge each other e.g., in a game of heads-up Texas Hold'em poker or in any other game which permits multiple players. Players may find or search for (or invite) other players to challenge using the app's ability to connect to players through the player's mobile phone contacts list, social network connections (e.g., Facebook or Google+). In still other embodiments, an open challenge list may be made available to players or potential players (e.g., delivered or originated by the game provider or created by prospective players). In certain of these embodiments, in order to enhance the perception of the provided games and experiences, players may be given the ability to chat using text, audio, and/or video messaging. In certain embodiments, this enhances the perception or better simulates the experience of a live, face-to-face heads-up Texas Hold'em poker (or other) game. In yet further embodiments, communication may be further augmented or supplemented with the availability of poker themed emoticons.

Certain examples of the invention are now described below with respect to certain non-limiting embodiments thereof as illustrated in the following drawings wherein:

### BRIEF DESCRIPTION OF CERTAIN EXAMPLE DRAWINGS

The drawings submitted with and which form a part of this patent application each illustrate an embodiment, or one or more components of an embodiment, of a non-limiting example of Applicants' invention. While these drawings depict certain preferred embodiments of Applicants' invention, as well as certain particularly desirable features thereof, they are intended to be examples only and should not be construed to limit the scope of Applicant's invention.

FIG. 1 illustrates one embodiment of a cable and/or data network, useful with one or more example embodiments of the present inventions.

FIG. 2 illustrates one example embodiment of a network connected playing card dealer table according to at least one non-limiting embodiment of the present invention.

FIGS. 3-41 illustrate non-limiting example screen shots of game play display views, example game mechanics, example game system configurations, and in certain views, example functionalities of example input device buttons, example game play settings, and example player wager data, player or dealer history, or other player options.

### DETAILED DESCRIPTION OF CERTAIN EXAMPLE EMBODIMENTS OF THE INVENTION

For a more complete understanding of the present invention, reference is now made to the following description of various illustrative and non-limiting embodiments thereof, taken in conjunction with the accompanying drawings in which like reference numbers indicate like features.

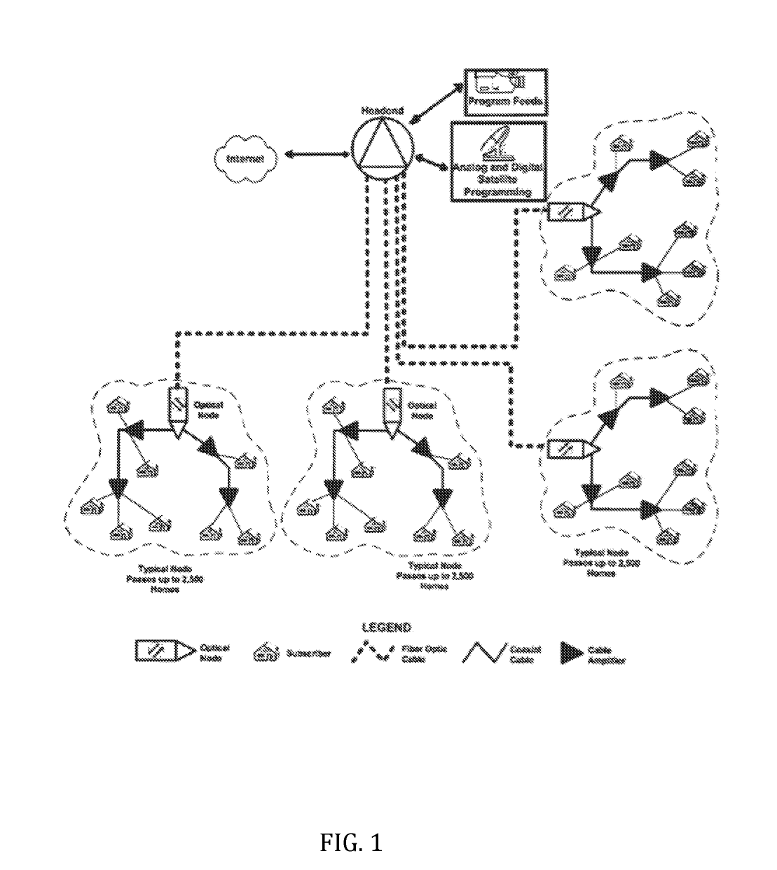

FIG. 1 illustrates at least one environment in which certain example embodiments of the subject invention find utility, are embodied in, are capable of being operated or implemented within, or are otherwise deployable in or deliverable thereby, such as to game players, participating in the games and/or systems described herein. In the example network illustrated in the figure, a cable television headend is shown illustrated as a central or master facility for television and other program feed signals for processing and distribution over the illustrated network system. The cable television headend will normally have a multitude of receive-only satellite television dishes for reception of broadcast signals from cable or satellite content networks. Satellite dishes may be provided at the headend for this purpose, to accept program content for distribution across the network which may be a coaxial cable, copper wire telephone-type, or fiber optic network, for example. Though other network types may of course be employed, the overall purpose of the illustrated network is to deploy entertainment content (or internet connectivity) to end viewers or customers, which may take place by delivering and distributing programming signals via local optical nodes which, in turn, further distribute the signals to individual homes utilizing set-top boxes (or other processing hardware), for example. Internet connectivity may be provided by using the same network, using the same delivery pathways, nodes, and/or channels, or by a separate network employing a different data exchange routes or delivery types. For example, television-type content may be delivered by the network illustrated in FIG. 1 whereas internet connectivity may be provided by a separate “in-ground” network, or direct to viewer/consumer homes (fully or partially bypassing an in-ground network) such as by personal satellite provided at or in viewer user homes (the reverse scenario is also possible). Cellular data networks may, of course, also be employed.

Using a network illustrated in FIG. 1 (or otherwise described above such as provided by satellite for example), bi-directional data traffic may be transmitted to and from consumers or users of the network. In other words, data may be sent to a consumer's home, and, conversely, a consumer may also send data from their home to another location, geographically remote from the home, which is also connected to the network (directly or indirectly). The use of the term “bi-directional”, in this regard, refers to the ability to send and receive data—as desired—without imposing specific definitions or limitations on the type of network which enables such “back and forth” data transmission or communication.

Using bi-directional networks, a game designer or provider can deliver or distribute a game, such as the games described herein, by sending data corresponding to the games visual appearance (e.g., including static graphics and/or live video feeds), audio components, rules of play, wagers and the like over the network to a consumer's or game player's home (or place of recreation or business for example). Similarly, if an interactive game is being supplied or delivered, the consumer or game player may send data, back over the same network pathways (or along similar but different pathways), to the game provider or distributor. In this manner, a game which is being provided but which requires interactivity, such as the implementation of player moves, decisions, or wagers, can receive such moves, decisions, or wagers (or information related to such moves, decisions, or wagers) from the consumer or player as delivered by the herein described (or similar) networks. Such moves, decisions, or wavers may be recorded or indicated or transmitted by any suitable method or mechanism including, but not limited to by or with, a keyboard, a mouse, a joytick, a touchscreen, a remote control, or with audio commands (or with commands recorded by detecting physical gestures).

In one embodiment of a system which utilizes a network, such as described herein, a game is delivered to a game player via a conventional internet connection, where the game player connects to the internet connection via an Ethernet or wireless internet (e.g., WiFi) connection (for example). Using such a communication method, a tailored web page may be chosen or designed to deliver a game, such as a playing card game, or a social network such as Facebook may be utilized. In other embodiments, a game may be delivered and played via hybrid network connections. For example, in a game in which a dealer table (and a live dealer, in preferred embodiments) is being video recorded and the video feed is displayed to a game player, the video feed can be transmitted in a conventional television broadcast, if desired (in addition to, as an alternative, over broadband internet connections). In such an embodiment, although no bi-directionality is provided with a conventional television broadcast, a set-top box may be enabled to allow transmission of data from the player to the game provider or dealer.

Similarly, the television broadcast could provide an opt-in code which, if texted via MMS or SMS by a mobile device or tablet to the game provider/dealer (for example), the mobile device or tablet may be linked or looped into the game (i.e., connected via a data network to the game), so that the game player can make game decisions, player moves, and player wagers using their mobile device or tablet (or similar communication device) while simultaneously watching the game being displayed on their television screen. In yet another embodiment, rather than employing an SMS or MMS invitation, a “join” code may be displayed in the television broadcast which can be entered at a desired URL (e.g., webpage) to join the play of a game (while continuing to watch the game—live—on the player's television screen). Of course, any other mechanism for allowing bi-directional data communication between a player and a game provider or dealer may be utilized.

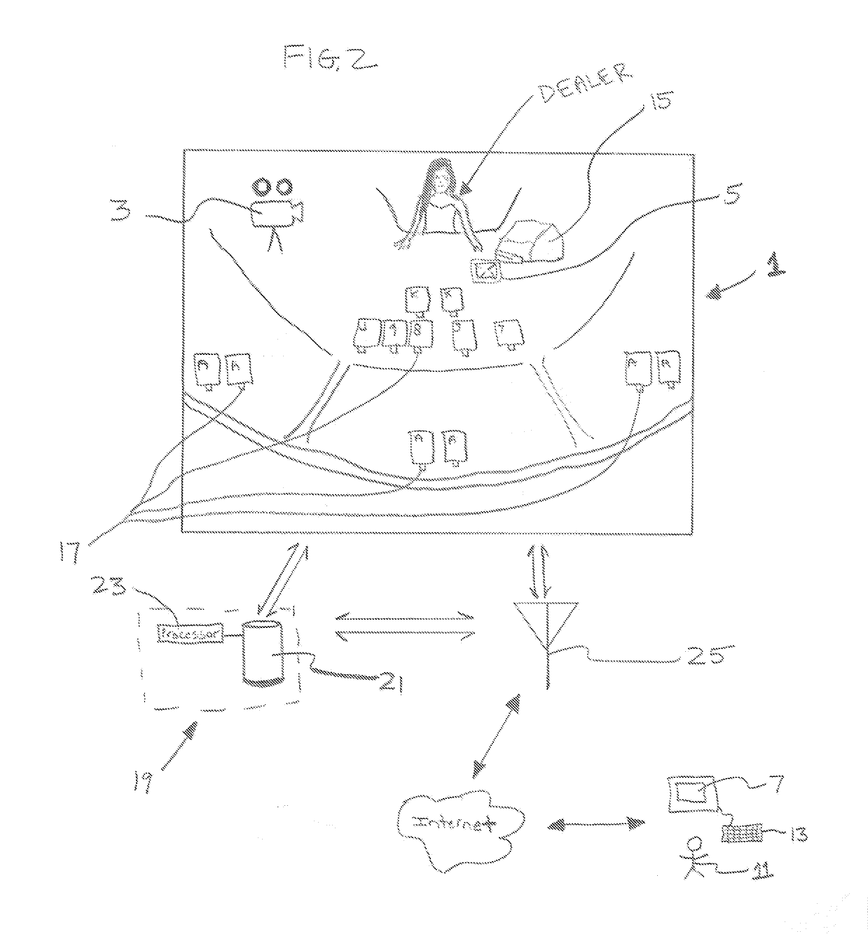

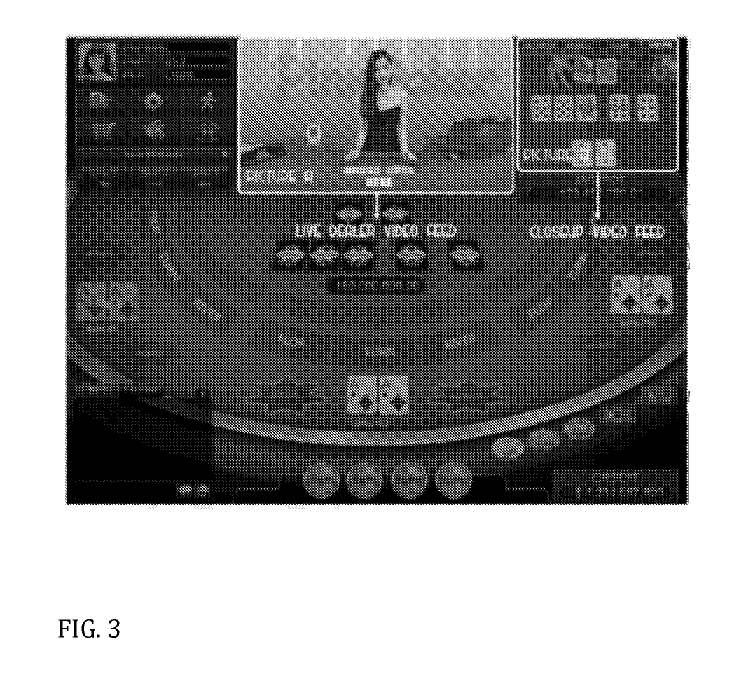

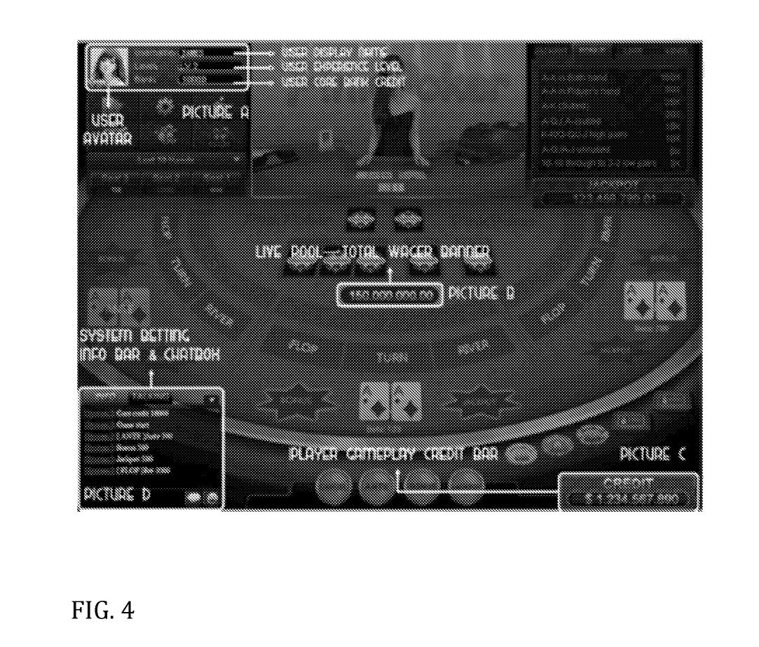

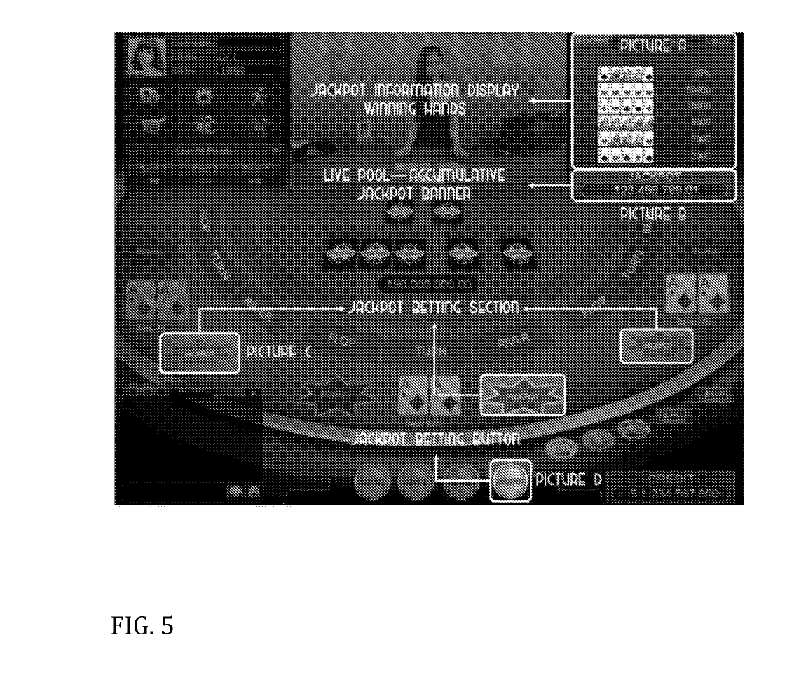

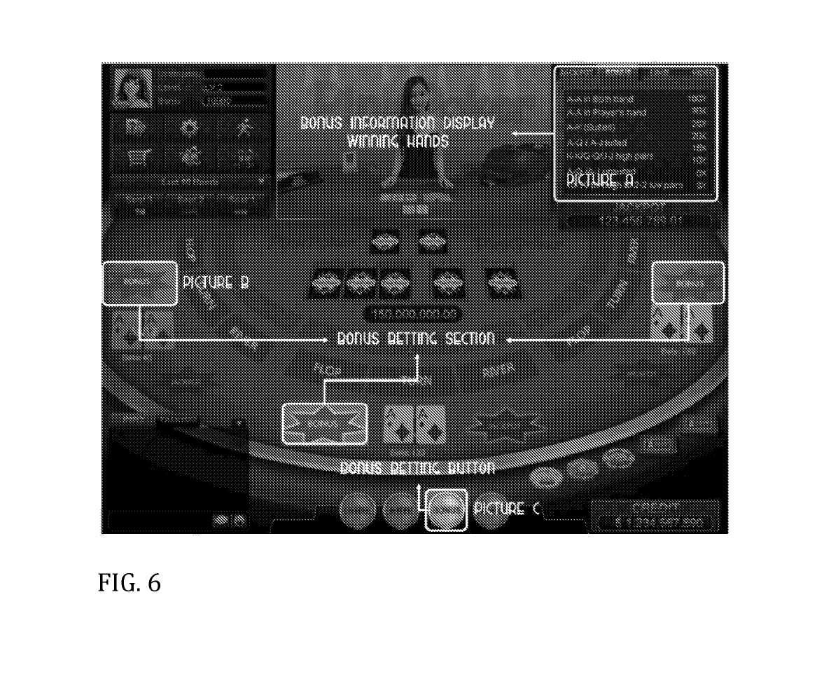

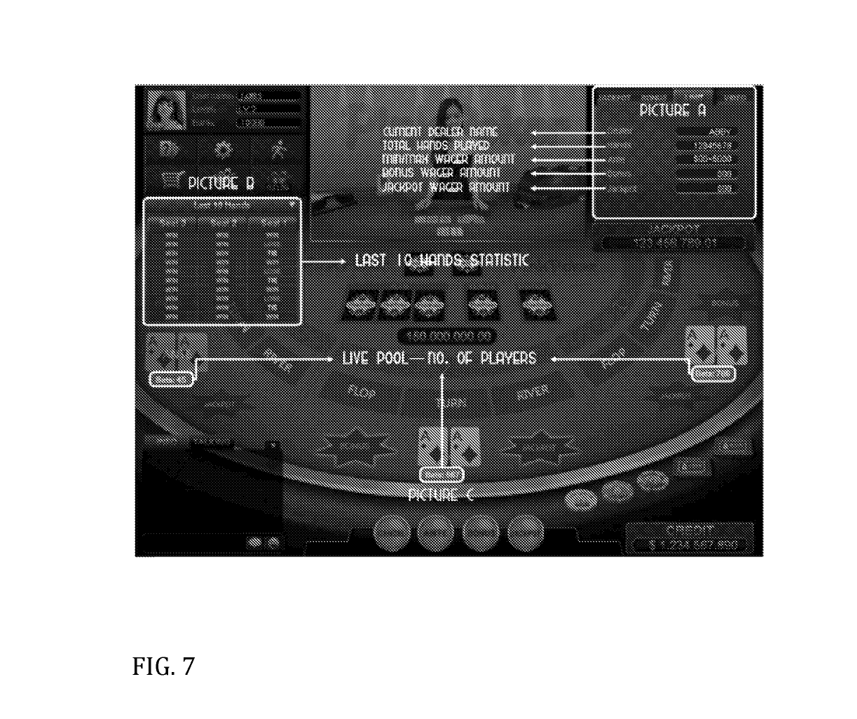

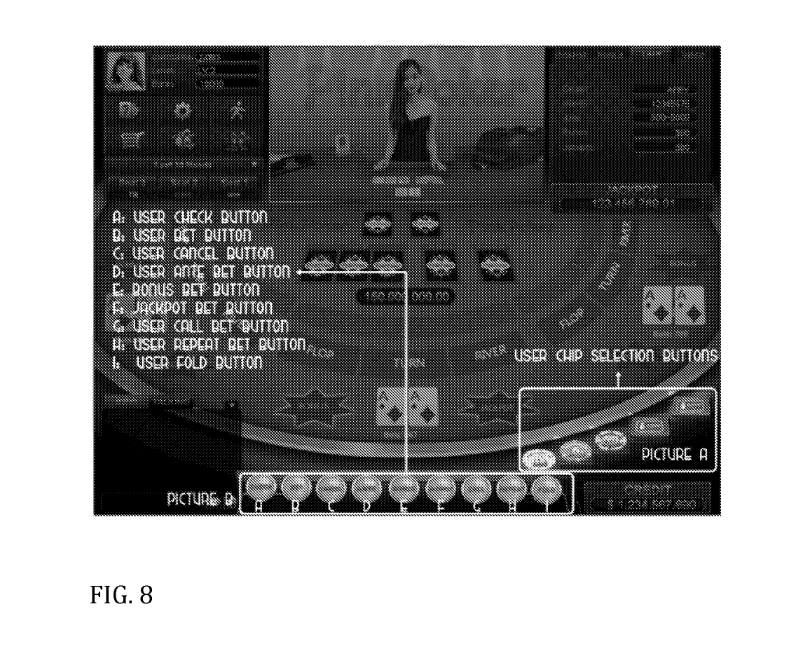

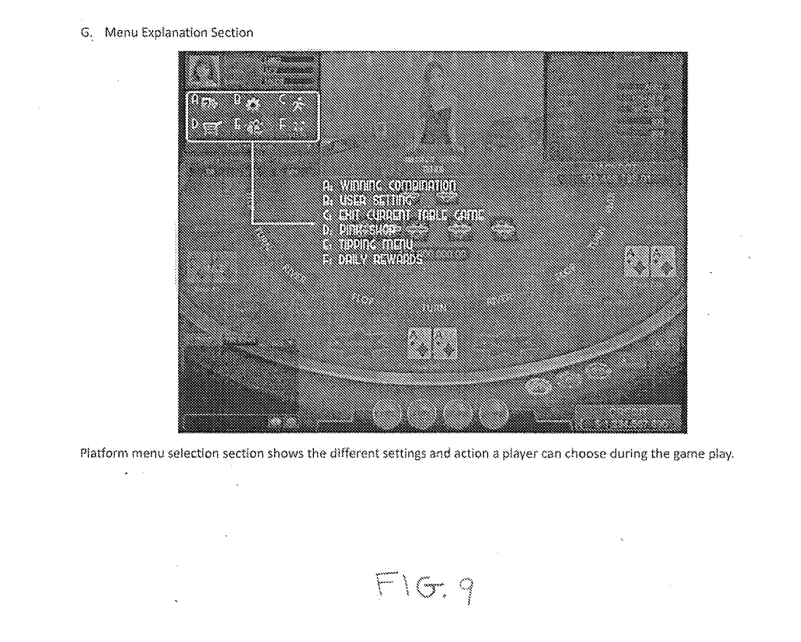

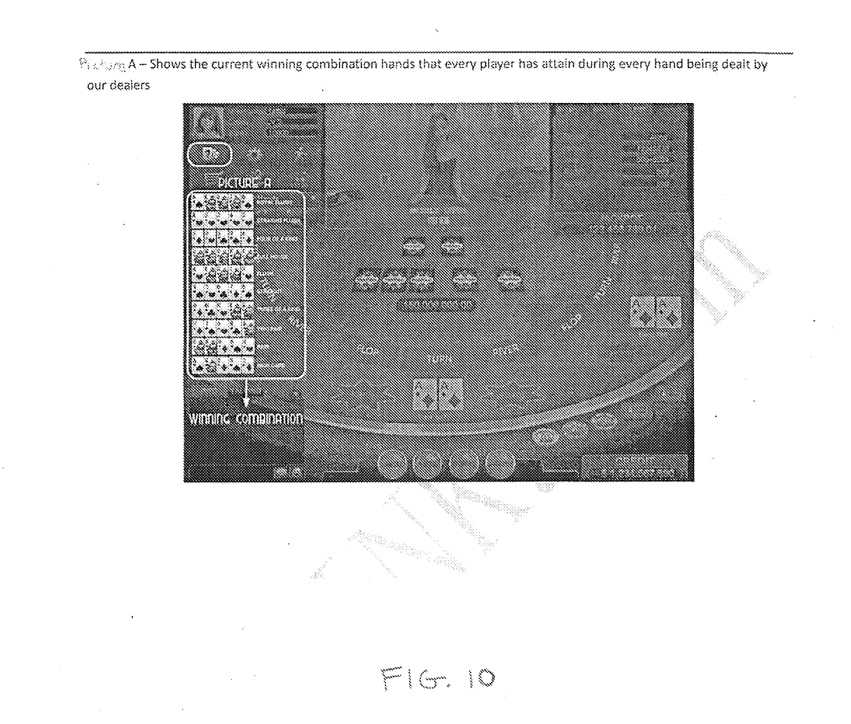

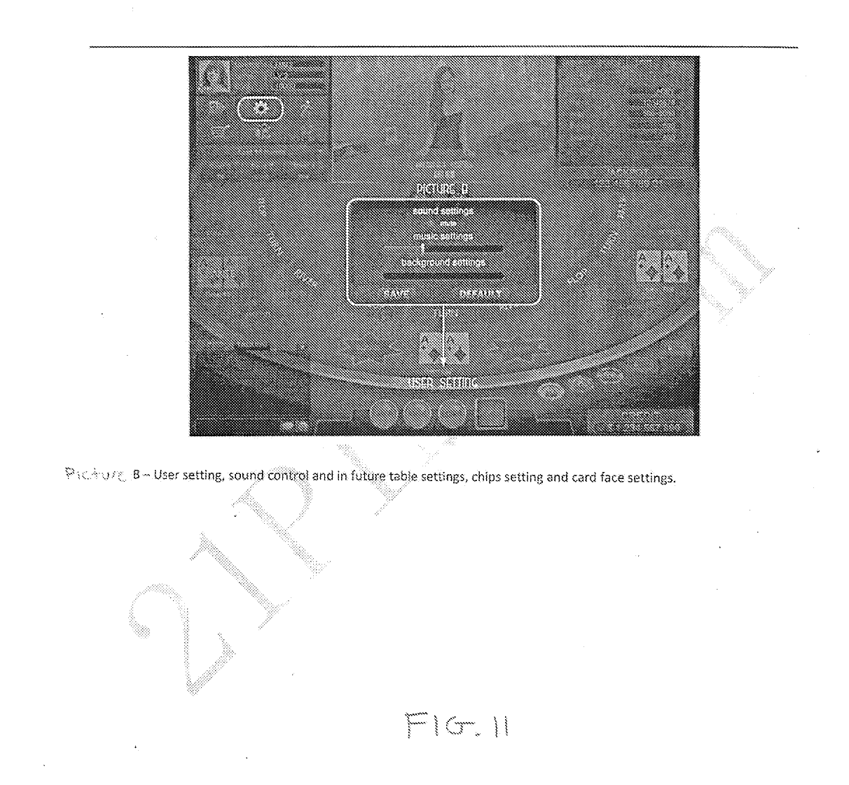

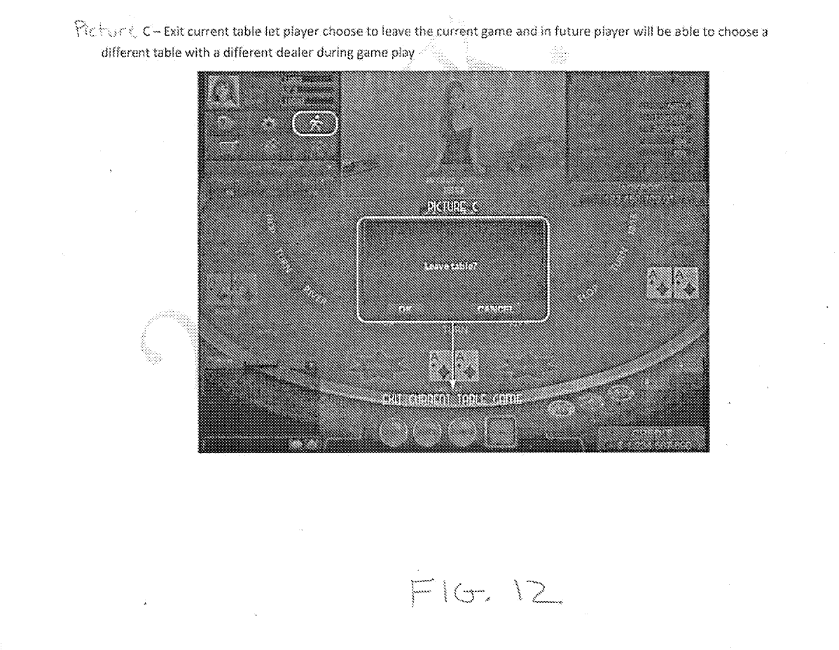

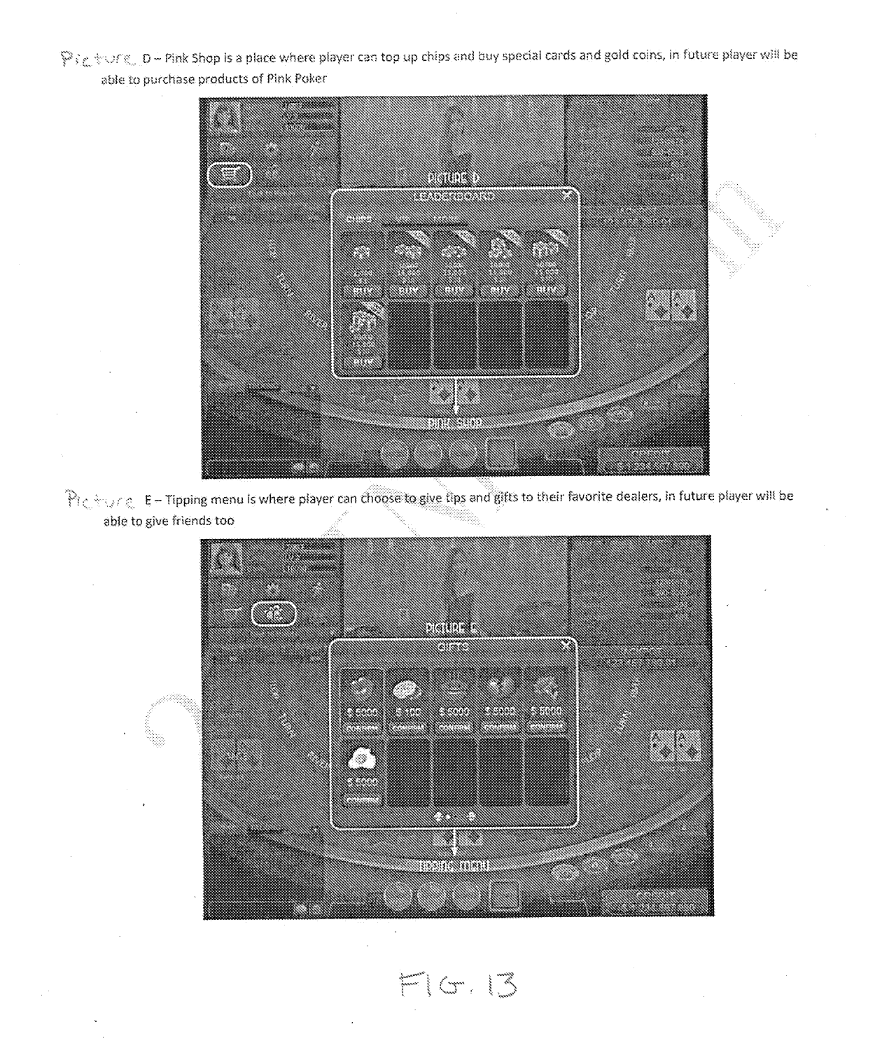

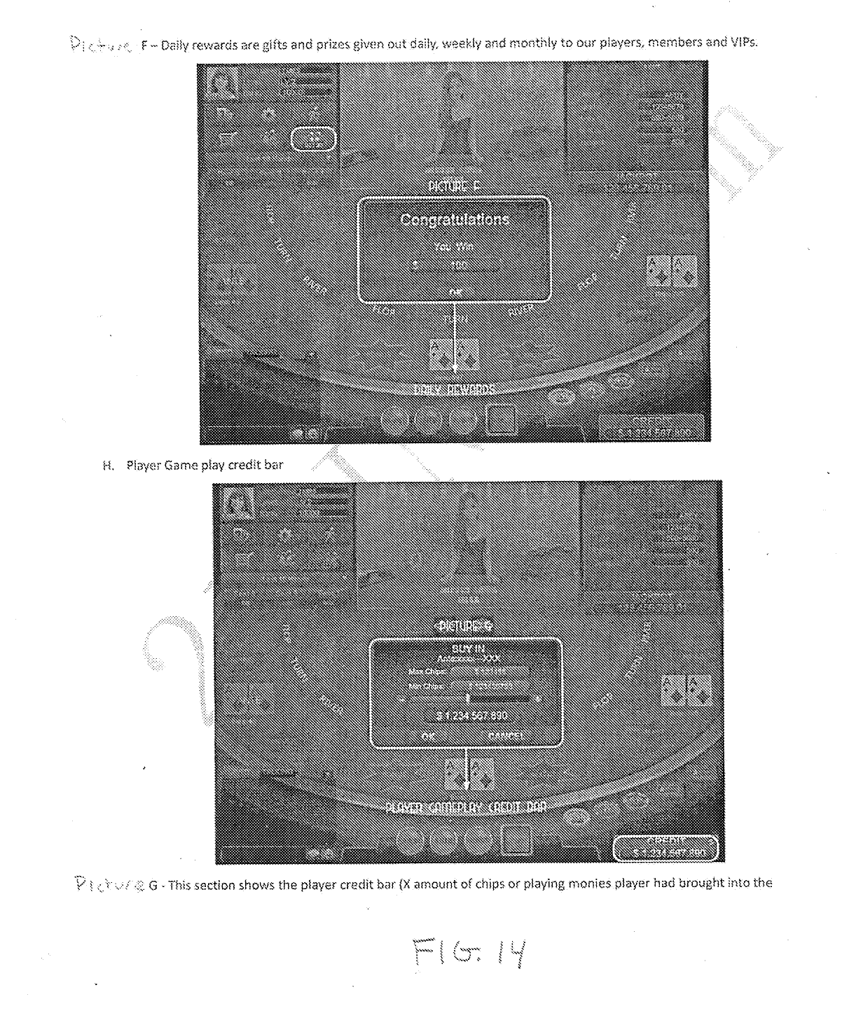

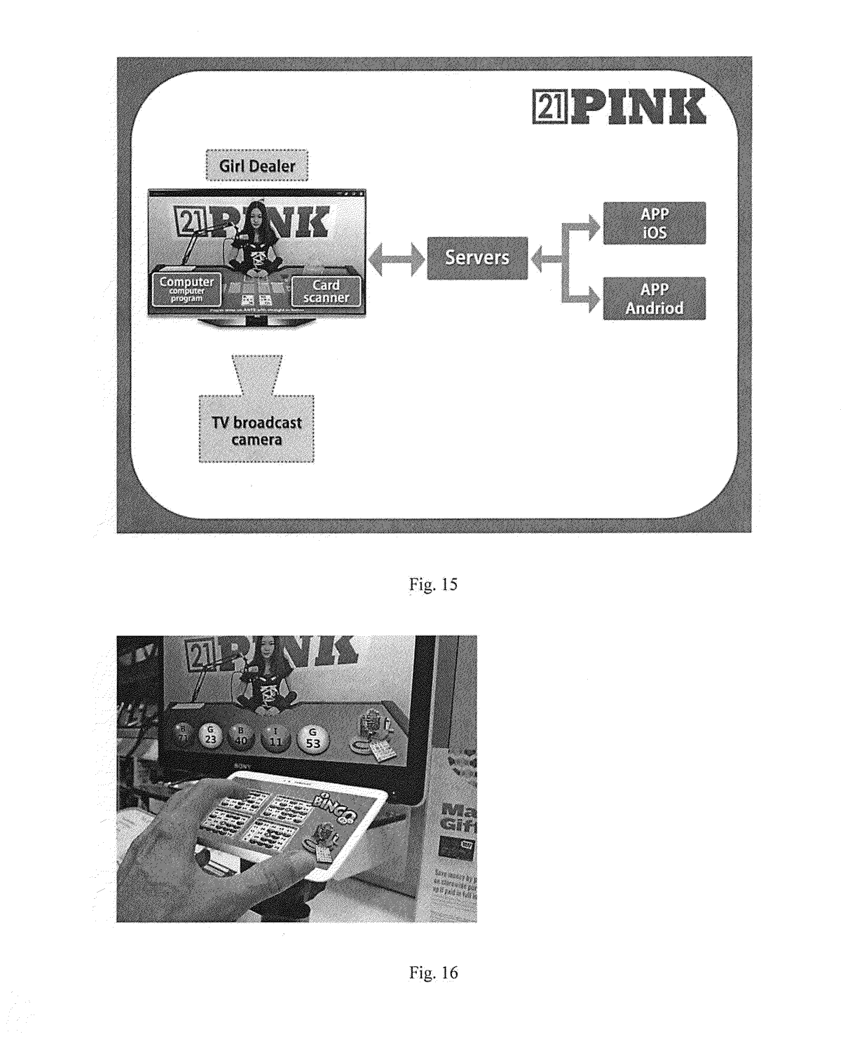

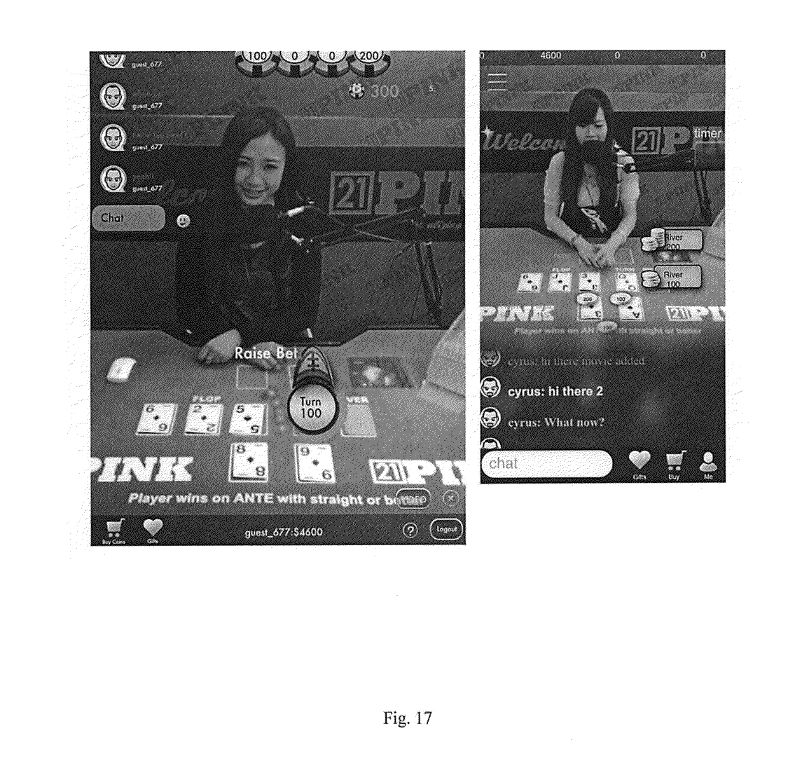

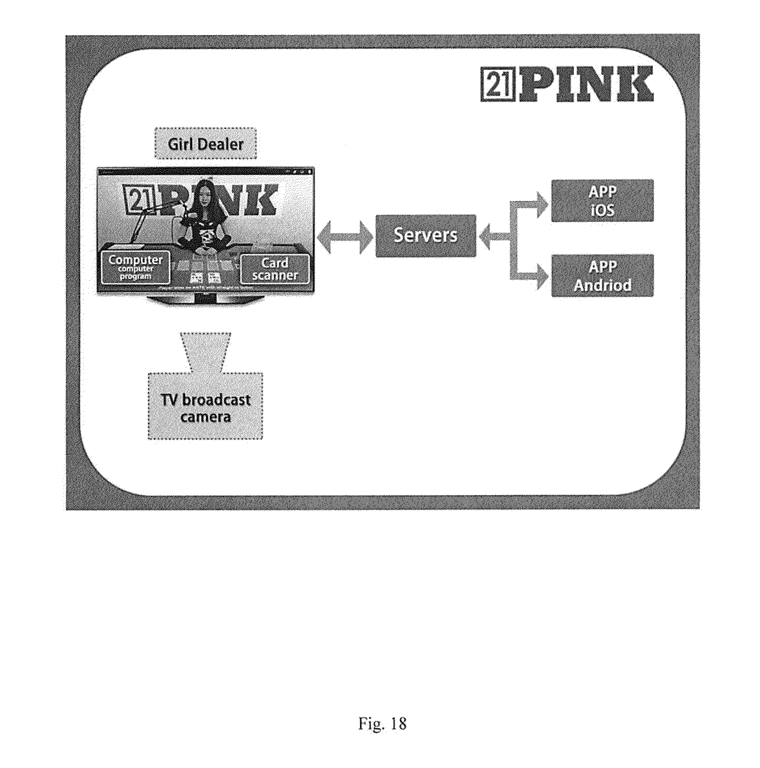

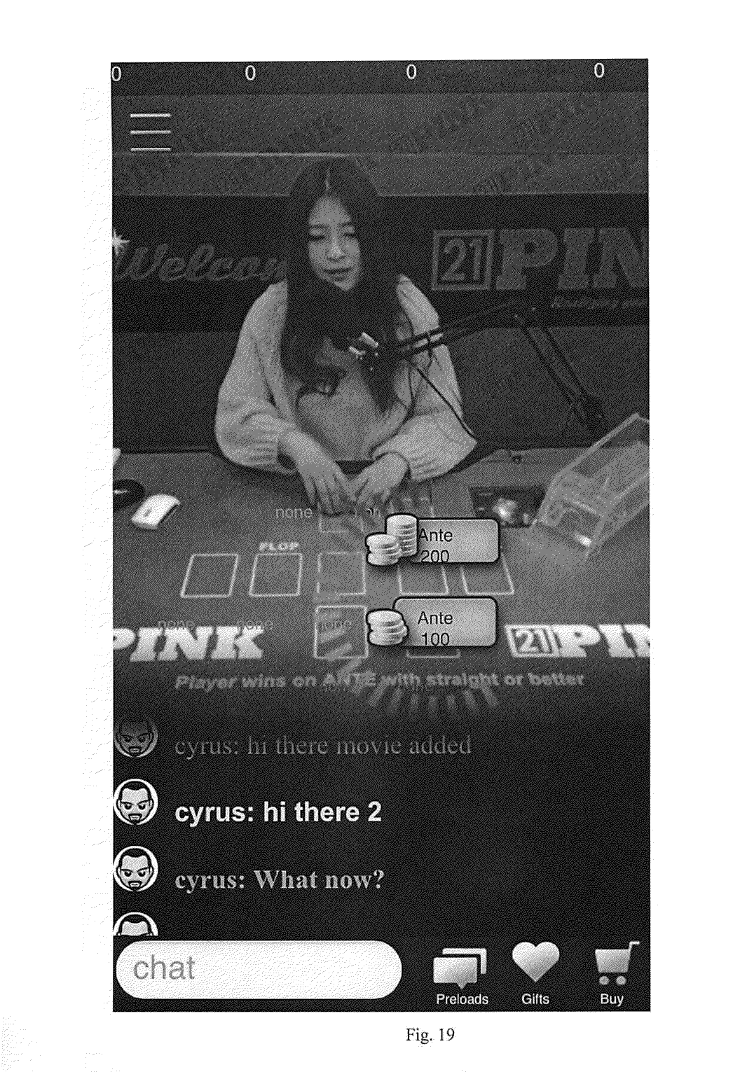

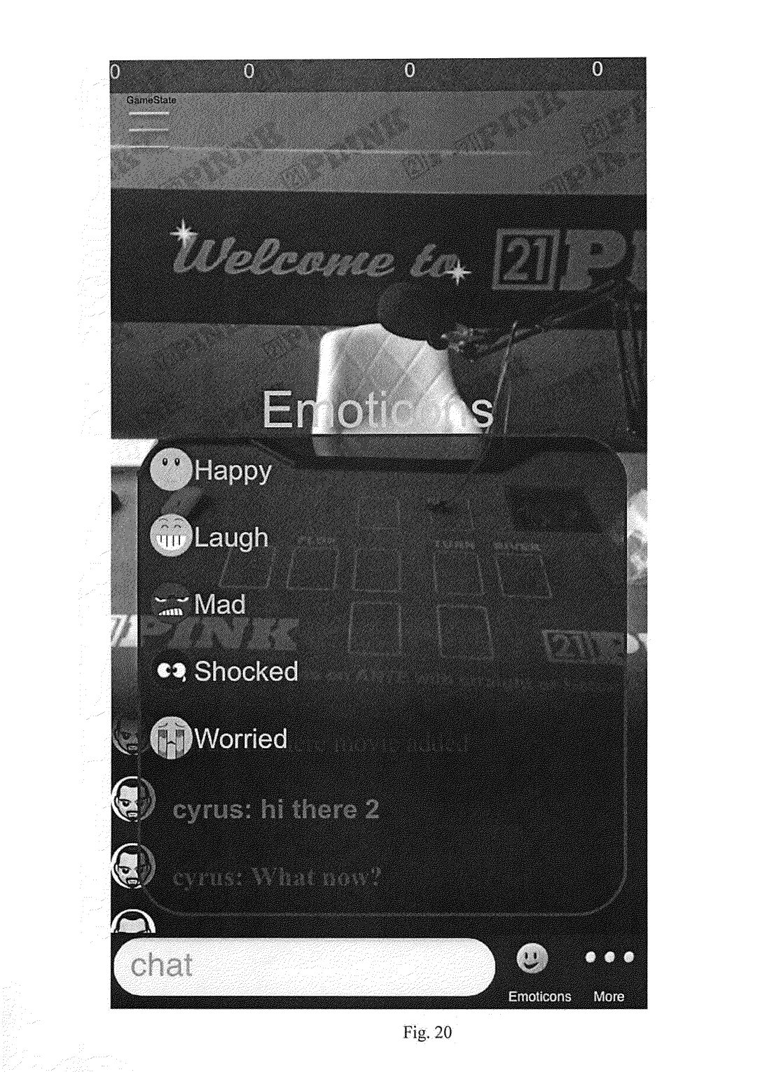

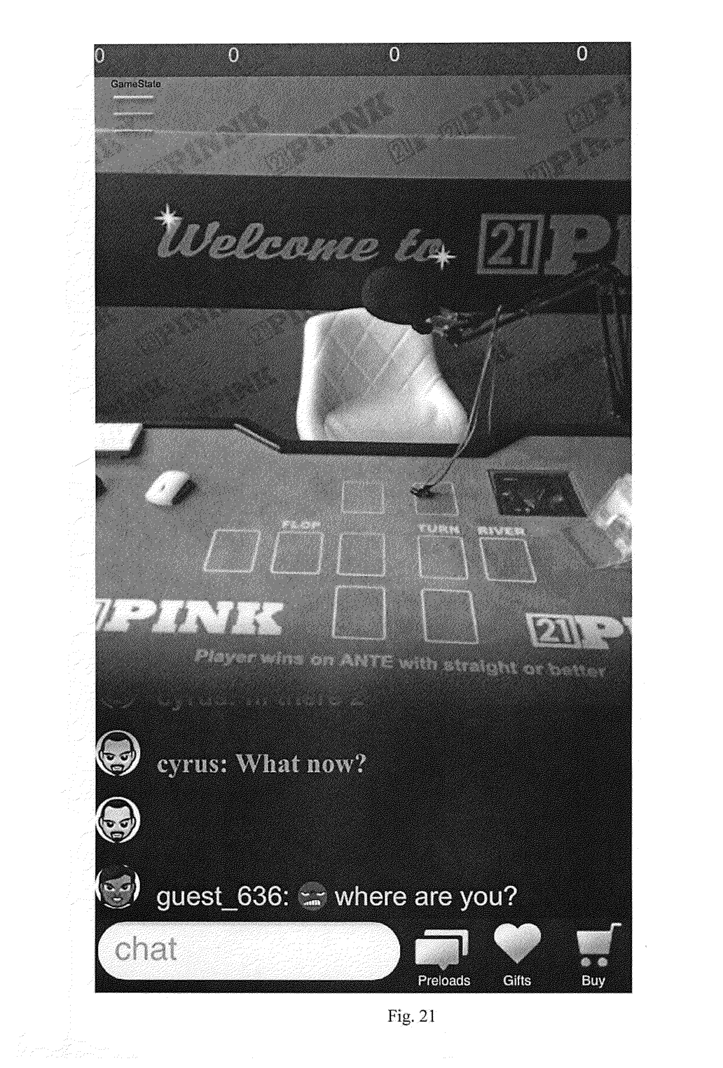

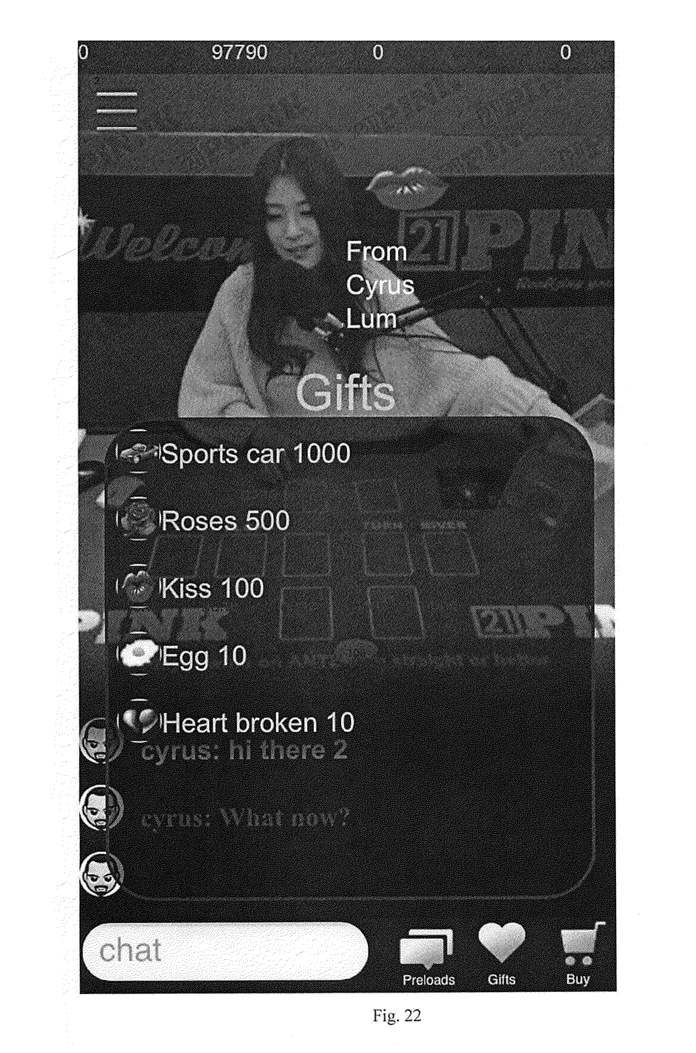

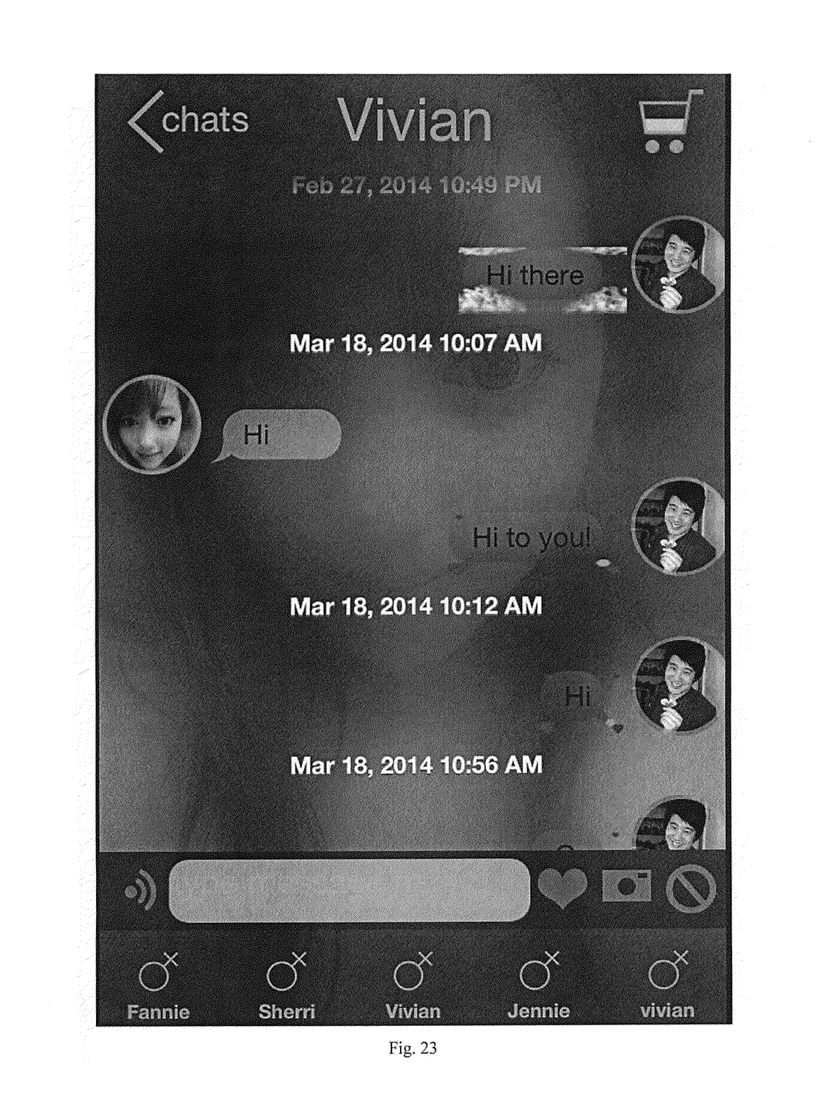

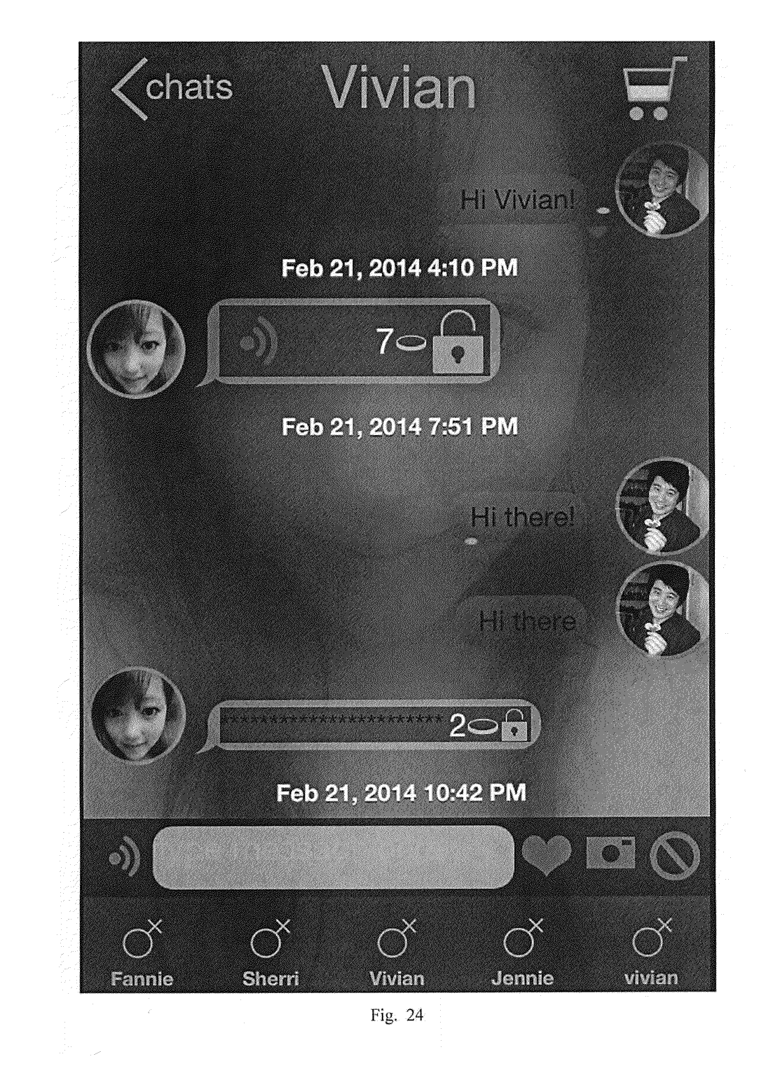

By way of specific, but non-limiting example, a playing card game may be played by game participants or players which are located at a location independent of the actual playing cards. For example, an electronically outfitted and network connected playing card dealer table 1, as illustrated in FIG. 2, may be utilized which is outfitted or associated with video or television broadcast cameras 3 as well as one or more scanner or detector devices 5 capable of scanning or detecting the rank and suit of playing cards dealt by a playing card dealer. Dealer table 1, because it may be video recorded (by provided video or similar image capturing cameras) and is otherwise electronically outfitted and network connected (as described in further detail below) can be located anywhere in the world, and manned by a dealer to deal playing cards, yet can be played by game players located any where else in the world, including at locations entirely geographically remote from the dealer table. In other words, game players can play the playing card game so long as network interconnectivity is possible at the locations of the game players (whether by in-ground network, cellular network, or any other suitable network connection type).

Specifically, in this embodiment, one or more game player display screens 7 are provided to players or participants of the playing card game 11. Such display screens may be specifically configured for displaying game play data and information, or they may be conventional display screens such as television screens, mobile device screens, or computer screens. Play input devices 13 are also preferably provided to remote players which permit players to indicate play decisions, card plays, game strategy, wagers, hits, folds, and the like. Such play input devices can include keyboard, computer mice, joysticks, touch screens, remote controls, audio commands, or commands recorded by detecting physical gestures (e.g., detected by infrared or laser detecting devices), or any combination or modification thereof. Decisions or moves or wagers indicated by use of such devices are transmitted to the game provider or dealer by a network, such as the networks described herein, e.g., as data which is stored and interpreted or de-coded if necessary, by a game processor and/or data storage device connected to the game processor. Action which takes place at the remotely located playing card dealer table 1 may, in turn be displayed or depicted to the game players on the one or more game player display screens. In this manner, players can view—as a live video feed—cards being dealt by a dealer, play decisions made by other players, wager information, and win/loss information.

In certain particularly preferred embodiments, playing card dealer table 1 is equipped with or outfitted with or associated with electronic playing card scanners. Utilizing such scanners, even though a live dealer (a real person) is being employed to deal playing cards, as each card is dealt (from an automated card shuffler 15, though manual shuffling can also be used), the provided scanners or detectors 5 detect the rank and suit of the card being dealt. This can accomplished by use of conventional barcodes, QR codes, or radio frequency identification (“RFID”) devices located on each playing card (of course, other mechanisms for scanning or detecting the card dealt may also be employed). The cards may also be interpreted by optical character recognition software encoded in the system (used in conjunction with a conventional scanner). Thus, in preferred embodiments, as each card is dealt, the provided scanner or detector determines the rank and suit of the card being dealt and then records (e.g., such as in a database) and/or transmits the rank and suit information to players or participants of the game (or to the game provider which may be monitoring the game). Similarly, but also optionally, additional scanners or detectors 17 may be provided on (or under or near) the surface of playing card dealer table 1 to detect or determine to whom or to which betting position a dealt card should be attributed. For example, scanners or detectors may be provided to detect if a card is dealt and placed in the dealer position (as part of the dealer's hand) or in a community card position (e.g., as part of “the Flop”) or in a position corresponding to one of several game players. Such detection or determination can take place by separate bar code or RFID scanning or detecting, or by simply matching an original rank/suit scan or detection to the closest-in-time placement of a card of a table (e.g., using a touch or card presence sensor in combination with a time stamp, for example). Specifically, by both determining the rank/suit and the person or dealer to which a card is assigned, such information about the physically dealt card may be automatically displayed on player display screens 7 (e.g., without requiring substantial or any further human intervention).

In embodiments in which card information is automatically detected and displayed, playing card dealer table 1 is preferably outfitted with, or at least communicably connected to, a game processor or computer 19 which includes a computer readable and writeable medium, such as a conventional hard drive or flash memory 21, in communication with a computer processor 23. Of course, the game processor or computer may be located anywhere, so long as it is provided with network connectivity (e.g., via antenna 25), but should preferably be placed in a secure location to ensure the integrity of the game (e.g., to prevent game tinkering or hacking). The computer readable and writeable memory preferably includes stored thereon a set of computer readable and executable instructions for processing by said computer processor.

The computer readable and executable instructions, in preferred embodiments, are defined to control the parameters of playing card game play as well as, optionally, to direct or control data traffic on the bi-directional network which is delivering or permitting the game play. In most preferred (but still optional) embodiments, the computer readable and executable instructions include game play and game win/loss rules, such that when such rules are processed by the computer processor, in combination with playing card rank/suit detection and playing card position or person attribution (e.g., provided to the game computer by scanners and detectors), the game computer 19 can determine winners and losers of the game without intervention or assistance of the game dealer or provider (e.g., except to physically deal cards or pass them over the scanner).

Similarly, wagers made by game players can be stored by the computer readable and writeable media, and then analyzed and processed by the game computer 19 to determine allocation or payout of game wagers. In other words, the game computer can allocate wager winnings to game winners automatically, without substantial or any human intervention, or can collect lost wagers for the game provider or dealer. Information pertaining to won and lost wagers may also be transmitted or displayed automatically to game players, via said bi-directional network, to or on the one or more game player display screens 7.

In at least one embodiment, a unique playing card game is provided as an improvement to traditional the traditional poker variant, Texas Hold'em. Such playing card game may optionally be implemented on the systems described herein. For example, remotely located players can participate in game play by viewing game display screens which are displaying video feeds of the playing card hands being dealt by a live dealer (e.g., utilizing playing card dealer table 1, or a similar electronically enable dealer table, such as described elsewhere herein). Addressing one or more of the above-described drawbacks or needs in the prior art (or other drawbacks or needs not specifically described herein), such unique game may be played as follows:

### Multi Hand Progressive Poker

### I. Introduction

Multi hand progressive Texas Hold'em is an alternative to regular Poker games. The game is played on a similar Blackjack-style table and is based on Texas Hold'em Poker. Multi hand progressive Texas Hold'em also offers an option of a Progressive Jackpot. All card play is against the dealer, and not other players.

### Sample Game Play Rules:

In the beginning of each hand, each player makes an Ante bet (the same as an opening bet in Poker), preferably in a designated box or boxes on the table (betting or wagering may be completed remotely, using devices as herein described above, such as to place bets in graphical depictions of betting boxes on a display screen). There is also the option of making a Progressive Jackpot/Bonus bet by placing a bet (of a specified amount) into a slot or location physically near or proximal the sides of the Ante bet (e.g., on an electronic display screen). A Progressive Jackpot/Bonus wager will win if the Player is dealt a Royal Flush, Straight Flush, Four of a Kind, Full House or Flush using their two cards and the five cards that are dealt in the community cards (Flop, Turn and River).

After placing an Ante bet and an optional Progressive Jackpot/Bonus bet, each betting section is dealt two cards face-up. These are called Hole cards. The dealer's hand is dealt last with two cards face-up. If a Player feels they cannot beat the dealer's hand, they may fold and surrender their Ante bet. Alternatively, if a Player has a hand which may beat the Dealer's hand, they must place an additional wager in the box marked Flop on the table (e.g., virtually or electronically as described elsewhere herein). This additional wager must always be twice the amount of the Player's Ante bet. In alternative embodiments of game versions, betting amounts are different and/or flexible and the player may be given the option to choose the bet amount (or the bet amount may be changed by the game operator).

After all betting sections or players have either made a flop bet or folded, the Dealer will then turn three cards face up on the table. This is called the Flop. The player may now make an optional third bet equal to their ante bet or the player may “check” (this means the player wishes to remain in the game but does not wish to make an additional wager).

After all betting sections or players have either made the additional bet or check, the dealer will turn a fourth card face up on the table. This card is called the Turn card. The player may now make an optional fourth bet equal to their ante bet or check. After all betting sections or players have either made the additional bet or check, the dealer will turn a fifth card face up on the table. This card is called the River card. The Flop, Turn and River cards are community cards and may be used by all the players at the table including the dealer.

After the River card, or last community card has been turned face up, each player makes their poker hand using any combination of their two Hole cards and the five community cards (i.e., to make the best five card hand, each player can use one, two or none of his hole cards in combination with the five face-up community cards). The Dealer makes their poker hand using any combination of the Dealer's two Hole cards and the five community cards (i.e., the Flop, Turn and River cards). A player wins if their best hand is ranked higher than the Dealer's and they will be paid at even money for the Flop, Turn and River wagers. Ante bets will only be paid (even money) if the Player's winning hand is a straight or better. If the Player wins but their hand is ranked lower than a straight, their Ante bet is a standoff (i.e., neither a win nor a loss). The Dealer will collect all wagers from the hands that rank lower than the Dealers.

### Progressive Jackpot Payout

### Royal Flush 90% of Jackpot

### Straight Flush 50000 of the Progressive Jackpot

### Four of a Kind 10000 of the Progressive Jackpot

Full house 8000 of the Progressive Jackpot

### Flush 5000 of the Progressive Jackpot

### Straight 2000 of the Progressive Jackpot

### Bonus Payout

A-A in both player and dealer hold card 100 times of bonus bet
A-A in player's hand 30 times of bonus bet

### Bonus & Jackpot Wagers

1. If a Player has made a BONUS or JACKPOT wager, the dealer will check to see if any Player's two hole cards win a BONUS or JACKPOT. This bet is independent of the five card poker hand, and may also be a winner even if the Players hand is a loser.
2. If a player has any pair in the hole card, that will be a BONUS winning hand. Other hole card combinations that usually win bonuses are A-A, A-K, A-Q, A-J etc. Each house may have its own different payout structure, which should be posted at the table.
3. If a Player hits a straight, that will be a JACKPOT winning hand (shown below). Other winning combinations that usually win jackpots are Full house, Flush, Four of a kind, straight flush and Royal Flush. Each house may have its own different payout structure, which should be posted at the table.
A-K Suited 25 times of bonus bet
A-Q/A-J Suited 20 times of bonus bet
A-K unsuited 15 times of bonus bet
K-K Q-Q J-J high pairs 10 times of bonus bet
A-Q/A-J unsuited 5 times of bonus bet
10-10 through to 2-2 low pairs 3 times of bonus bet

| Game play time (estimated Per Hand) | 2 minutes |
|---|---|
| Estimated player winning percentage | 30% |
| Actual player winning percentage | 29% |

Of course, the above payout and betting structures are preferred examples only, and other structures may be used. For example, while the flop bet is described above as twice the ante bet, this bet structure or rule may be changed by the game operator or designer. Alternatively, different betting structures or rules may be agreed upon by players in multi-player games. In fact, any bet structure, rule, amount, or ratio may be changed or determined by the game operator. For example, alternative bet structures may be “permanently” designed into a game, or the game may provide an interface by which betting structures, rules, amounts, or ratios may be selected, changed, or tailored whenever desired by the game operator (or by players if permitted by the game operator). Similarly, jackpot and bonus amounts, structures, and/or ratios can also be set and/or adjusted by the game operator (or by players, when appropriate, if permitted by the game operator).

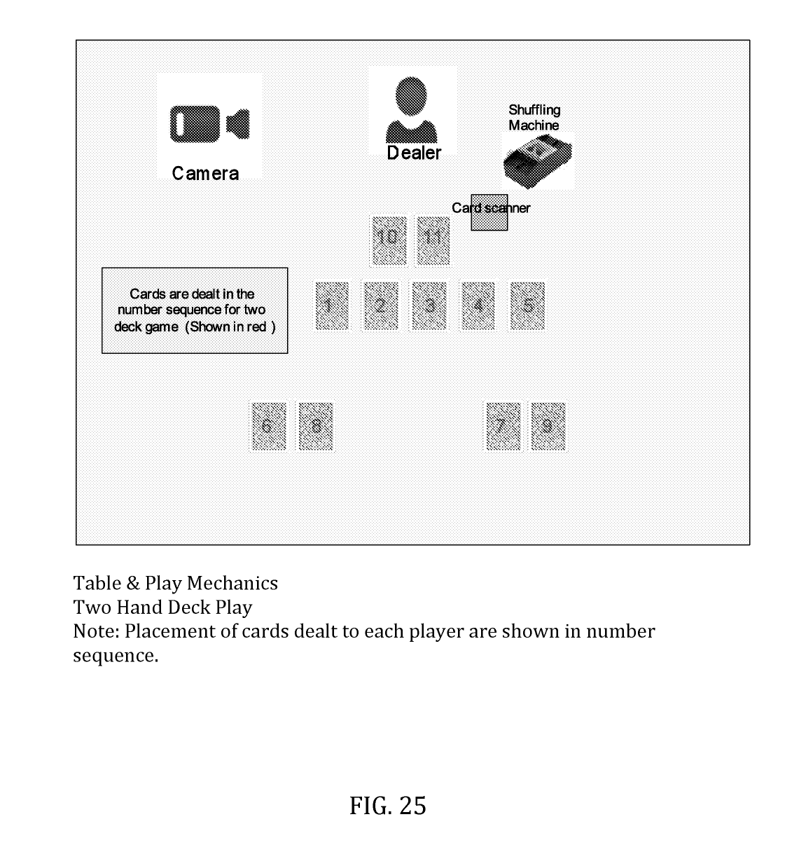

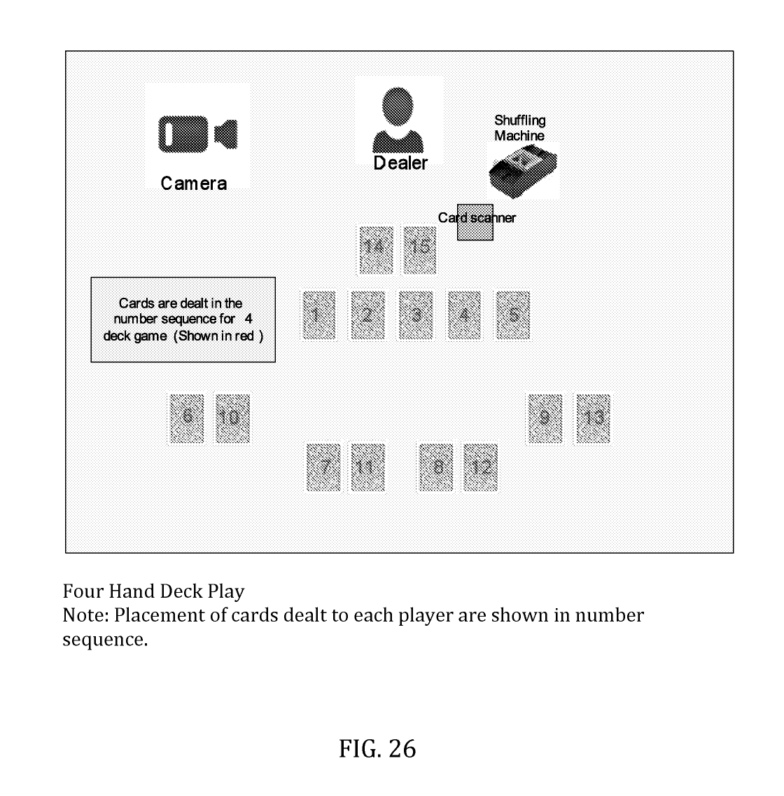

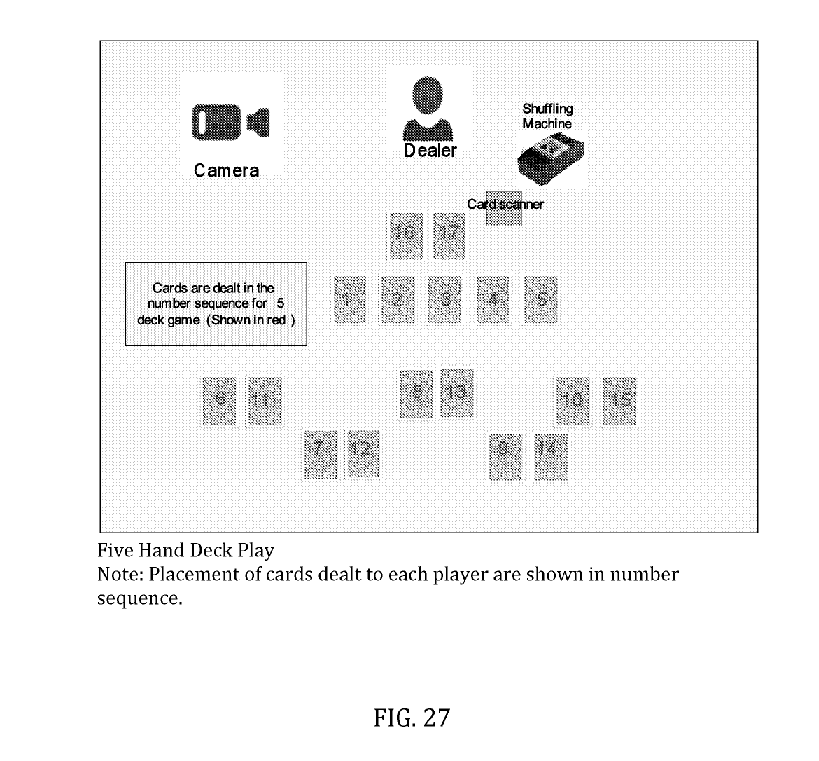

In certain embodiments of the multi hand progressive games described herein, in order to enhance playing and/ore betting options, a single player may be permitted to play card hands in addition to the first or main hand (i.e., a player can play more than one hand at the same time). For example, a single player may place 2, 3, 4, or even 5 or more hands. In such an instance, the general rules and card deal sequences would remain the same, with each additional hand being dealt in sequence with other hands. Example card deal sequences for 2, 4, and 5 hand games are disclosed in FIGS. 25, 26, and 27. The number of hands permissible to be played by a player are limitless, so long as additional decks can be added to the game play (when or if needed) to account for use of cards by such extra hands.

Non-Limiting Example of Game Implementation:

In one example “walk-through” of the implementation of a non-limiting embodiment of a game described herein, a game of casino-style Texas Hold'em is provided for remote game play. In this example embodiment, the game “mechanics” are provided to players via a software module or software “app”, installed on an electronic device which communicates with a game provider software program, installed on a game provider (or moderator) server or central processing computer. Game player apps or modules are downloaded and installed onto chosen electronic devices (such as mobile phones or other devices, laptops, computers, etc.) before use. Once installed, both the program executable for the dealer/game moderator and separately for the game player can be launched, which will initialize the beginning of, and thereafter “run”, the game. Live broadcast cameras will be installed and will be active, thereby broadcasting the actions of the dealer/game moderator to an audience (e.g., over conventional TV broadcast signals or via other methods or channels). In this example, the dealer/moderator will first be presented with an interface prompting the dealer/moderator to start the game and deal 5 community cards, then the dealer will deal two cards for the game player, and then the dealer will deal two cards for the dealer. All cards will be dealt face-down.

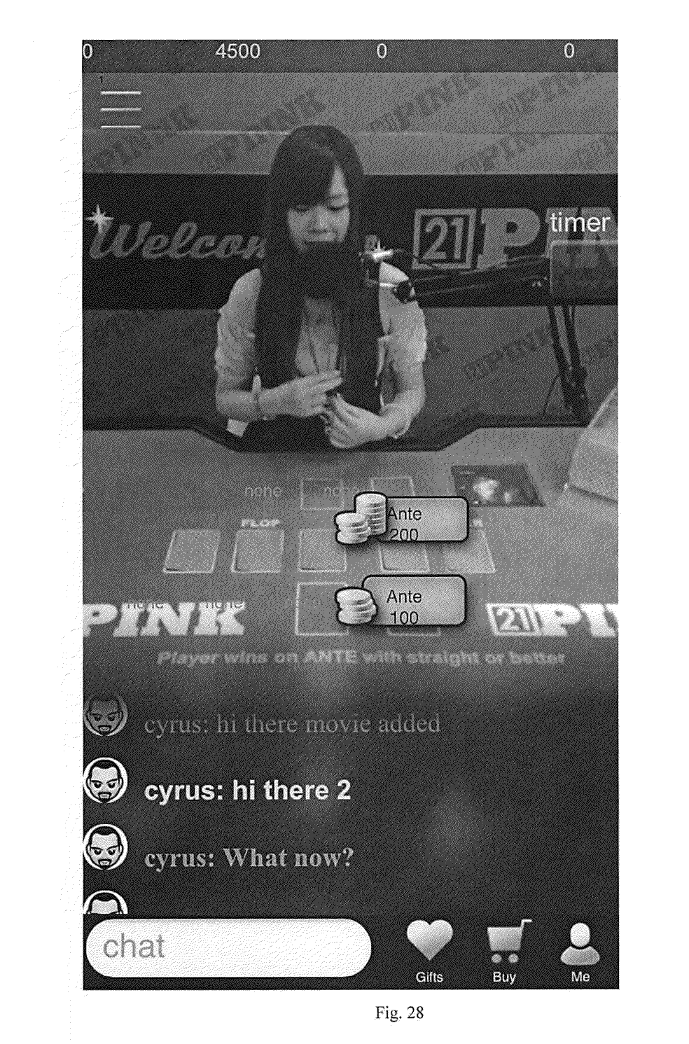

The game player, subsequent to launching the app on their chosen device, will be notified that a new game is starting and prompted to place a bet to participate in the game within a specific amount of time. A timer, in this example embodiment, is presented to indicate the amount of time left to place a bet to participate in the current game. See, e.g., FIG. 28. Once the time has expired, the game player app will send a notification to the dealer/moderator's program about all of the players who placed a bet before the time limit was up (the plurality of game player “apps” being collectively referred hereto as the “game player app”). After time has expired, the dealer software program will also, in turn, send a notification to those game players who did not make a bet in time notifying such individuals that they are not participants in the current game. In sum, all players that joined or placed bets on time will be permitted to participate in the game, while persons that missed the deadline must sit the hand out until another game or hand begins.

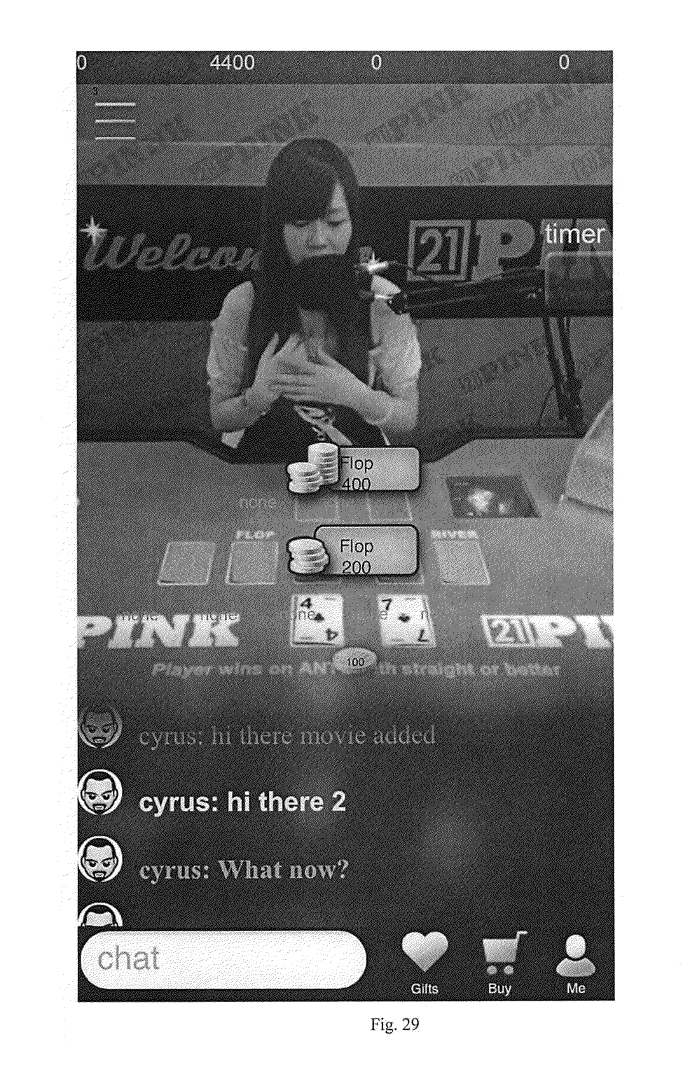

Next, the dealer will scan the two player cards (with a provided scanner which scans for codes or installed card identification devices) before flipping them over to reveal them on broadcast TV (e.g., to players as well as to non-playing viewers). See, e.g., FIG. 29. Upon scanning the cards with the scanner, the card values will be broadcast to all connected game player devices who are eligible to continue in the game. On the game player app, the game player will be able to see a simulated representation (e.g., pictorial or graphical representation) of their cards along side a live view of the dealer/game broadcast showing the actual physical cards dealt.

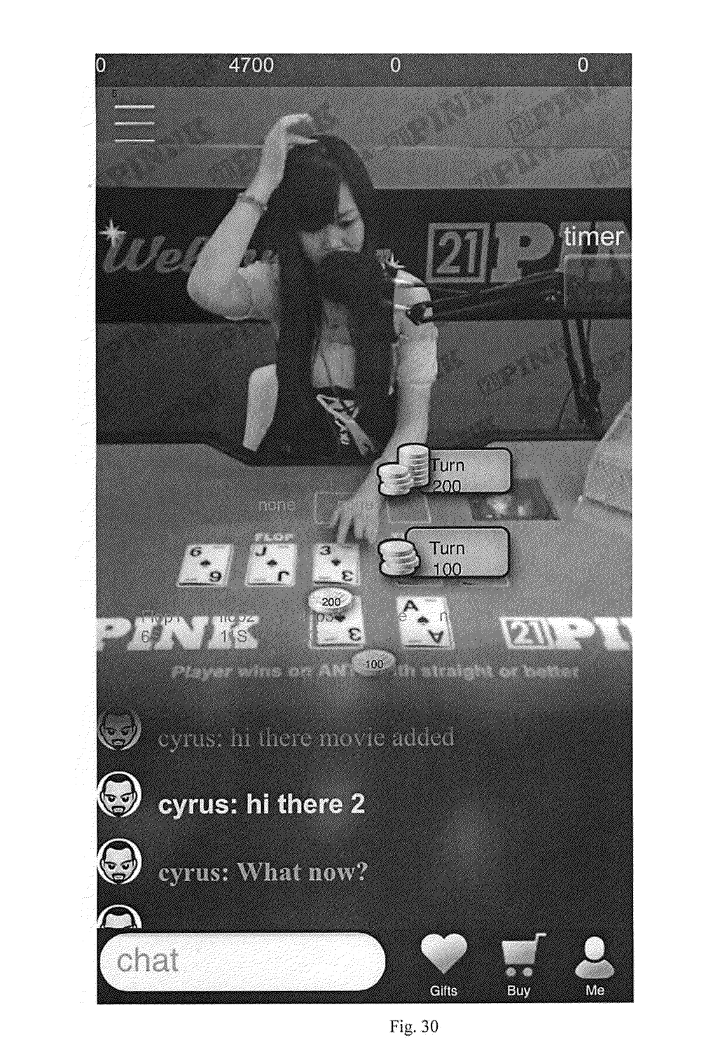

In the next game step, the player or players is/are prompted to place a bet for the flop before a specified amount of time is up. Once the time is up, the participating game player apps will notify the dealer program about their bets and status (by transmission of corresponding data over the network being used). Further, the dealer program will send a notification to those game playing apps that have not placed a bet that they are no longer participating in the current game. Afterwards, the dealer scans the first three community cards and broadcasts their identity (i.e., values and suits) to the participating game player devices and also flips each card over, so that they are visible to the broadcast cameras, to reveal them on live video. See, e.g., FIG. 30.

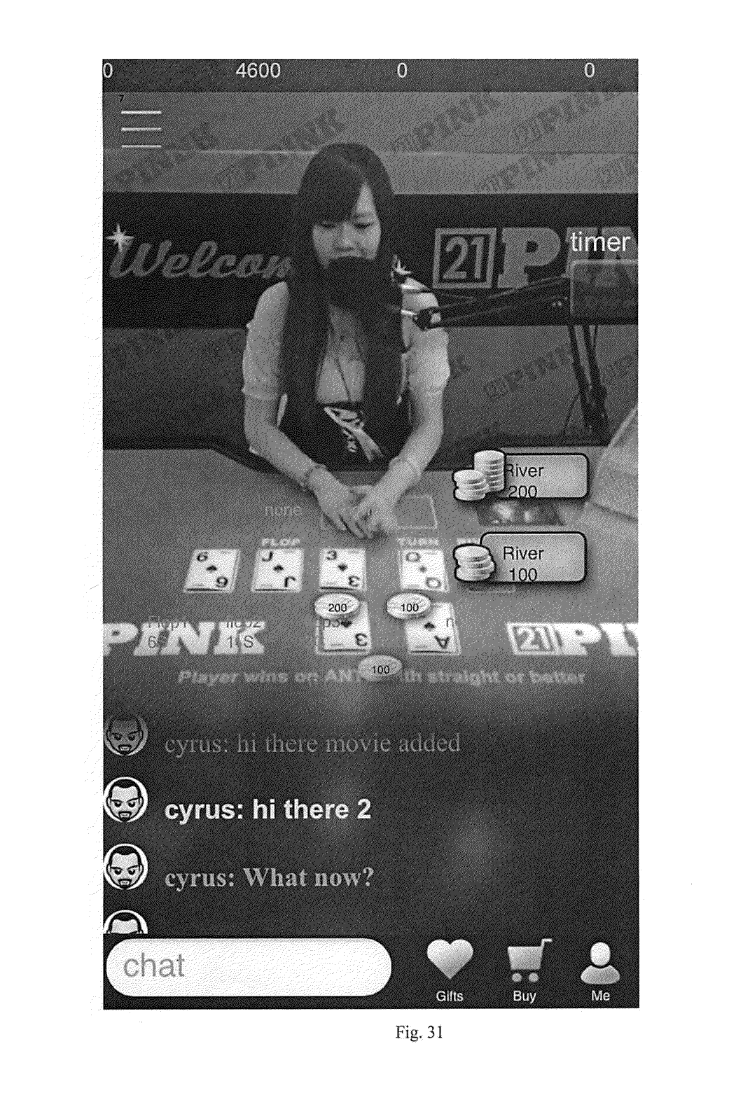

Next, the game player app prompts the player(s) to place a bet for the fourth community card, also known as the “turn” card, before a specified amount of time is up. Once the specified time is up, the still participating game player apps will notify the dealer program about their bets and status (i.e., again, by sending data over the network). Once again, the dealer program will send a notification to those game playing apps that have not placed a bet advising or notifying such players that they are no longer participating in the current game. The dealer, thereafter, scans the fourth community card, transmits the card value and suit to the participating game player devices, and then flips that card so that it is visible to the broadcast cameras so that it is revealed on live video. See, e.g., FIG. 31.

The game player app, next, prompts the player(s) to place a bet for the fifth community card, also known as the “river”, card before a specified amount of time is up. Once the time is up, the participating game player apps will notify the dealer program about their bets and status. The dealer program will send a notification to those game playing apps advising that have not placed a bet that they are no longer participating in the current game. Afterwards, the dealer scans the fifth community card to broadcast to the participating game player devices and flips that card to reveal it on live video.

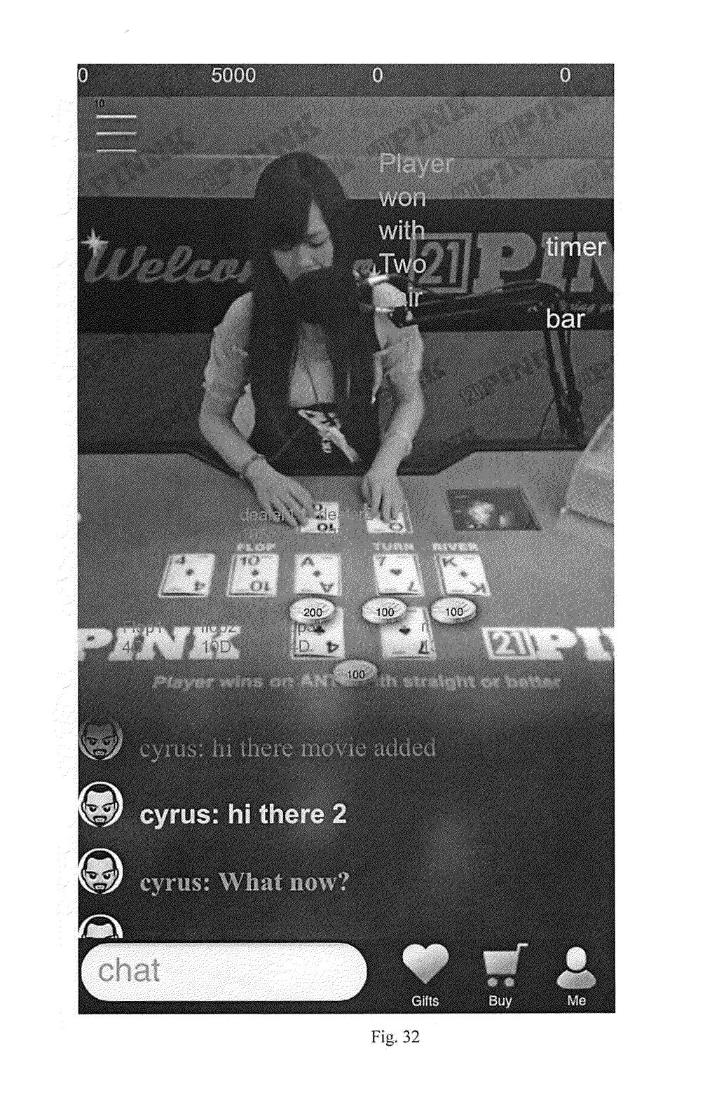

Next, the dealer will scan each of his/her two cards to broadcast to the participating game player devices and then he/she will flip those cards to reveal them on live TV. Since the cards (scanned or detected) and bets are all processed by the provided software (which processes card and bet data according to preset game rules), winners and payout amounts (if any) are automatically calculated and the dealer program automatically notifies all participating game player apps of the game results and automatically makes wager payouts according to the individual game player wagers. See, e.g., FIG. 32. Once a game is concluded, a new game may start again repeating the same pattern as described above.

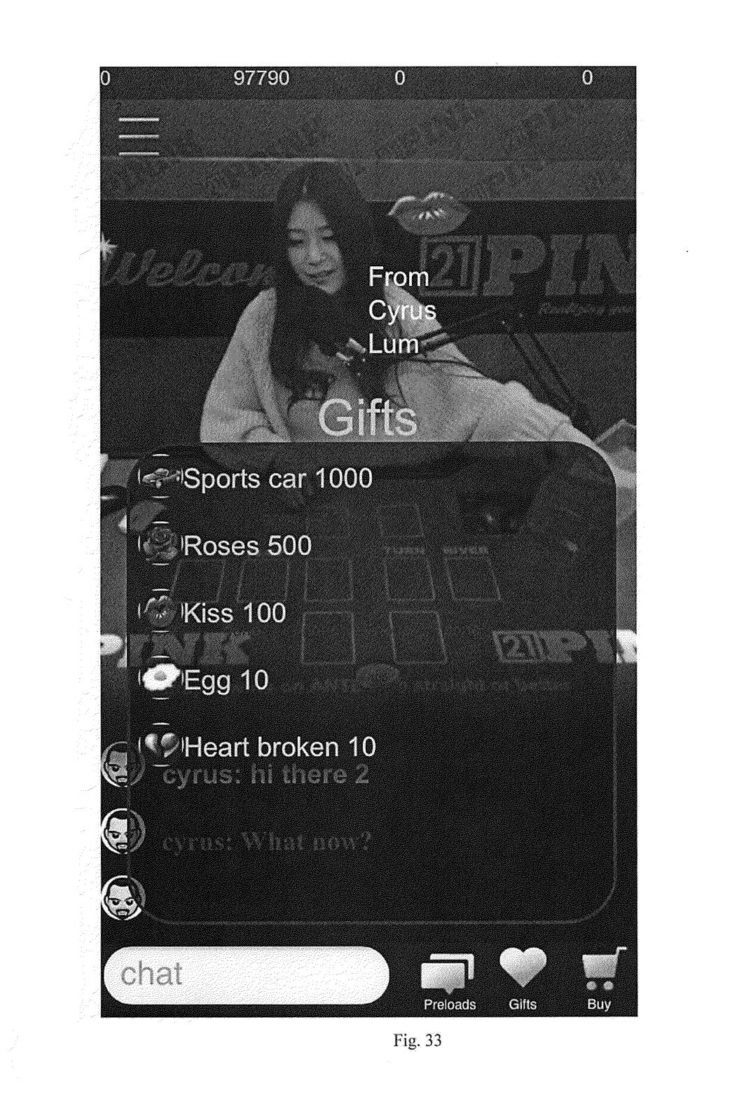

In certain embodiments of the described game, game players may engage in chat or other communications with the dealer during the game. This may be accomplished using software components that allow transmission of text, audio, images, and/or video. To enable such chat or other communications, the game player can tap on a chat button, type, compose a message, and then send the composed message to the dealer who will receive the message in his/her dealer station. The dealer may also communicate with the players and, for example, may respond by also tapping on a chat message method and sending a composed message back to the game player that originated the communication. Additionally, during a game, game players may send tips in the form of virtual gifts to the dealer. To do so, the game player can tap on a provided gift button (e.g., generated by a software app installed on the game players electronic device) which will slide open (or otherwise open) a gift menu. Tapping on any one of these gifts, in this optional embodiment, will automatically send the selected gift to the dealer. See, e.g., FIG. 33.

Non-Limiting Example of Head-to-Head or Challenge Game:

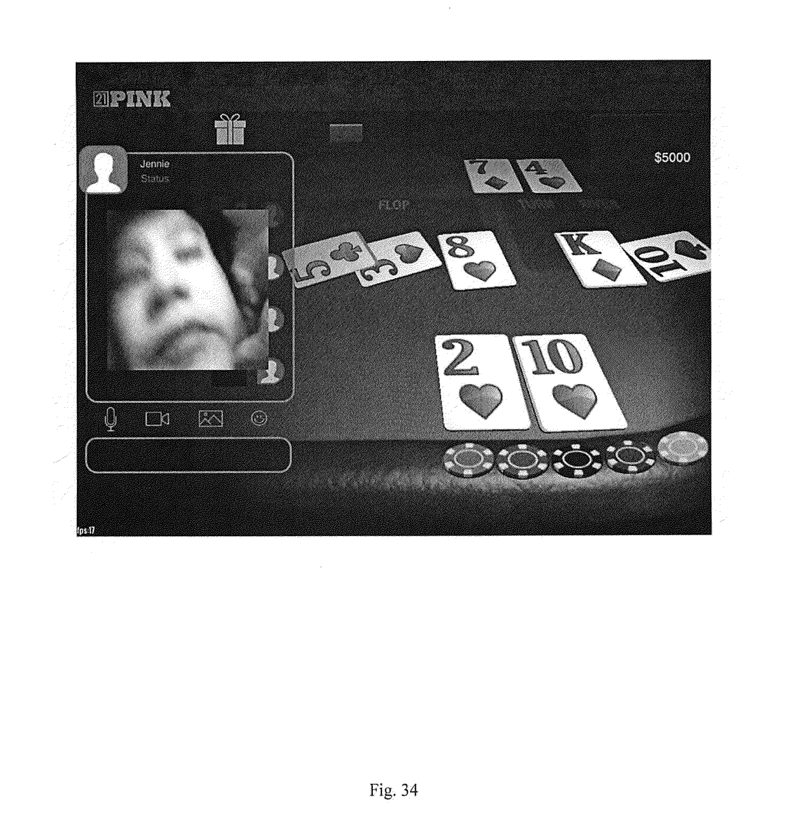

In another example game embodiment, players may “publicly” or privately challenge other prospective players to provide excitement to game viewers and participants. These challenges are simulations of the head-to-head challenges which occur in movies and in professional card matches, and allow remote game players to experience the feel, competition, and adrenaline of such matches. To further enhance the experience, two or more players can chat with each other (including, for example, with video chat) engaging in live, fun or taunting banter. See, e.g., FIG. 34. Chats and similar communications can include text, photo, image, voice, and/or video messaging to allow players facing off to simulate the experience of sitting at the same geographical location facing one another (all while being geographically remote, regardless of distance, but using the benefit of electronic devices to bring the experience home).

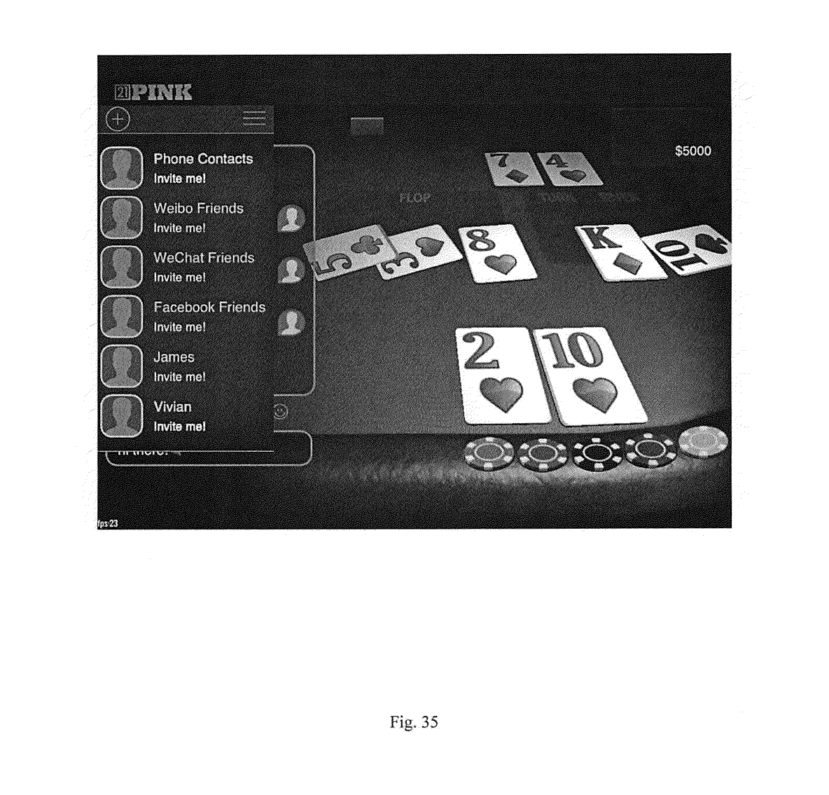

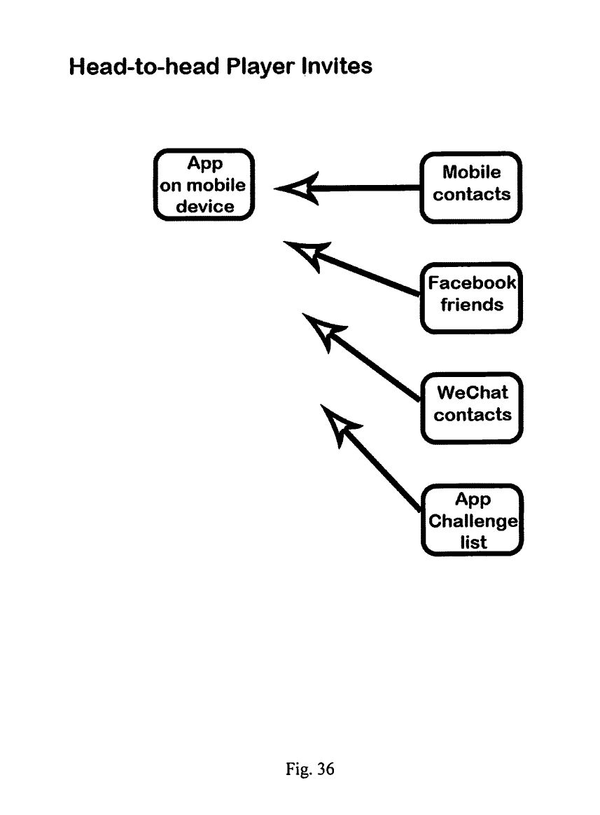

In at least one embodiment, the software apps provide allow players to challenge each other to a game of head-2-head Texas Hold'em poker by finding each other through mobile phone contact lists, social networks (such as Facebook or Google+) or through open challenge lists as made available in the app. See, e.g., FIGS. 35 and 36. In preferred embodiments, once the challenge is initiated and the game commences, game interaction and communications preferably occur in real time. The system may also include a computer program known as a chat server to host the chat communication between players in the same game.

In the following “walk through” of an example embodiment of a head-to-head or challenge game implementation—just as with other embodiments described herein—the game mechanics are delivered by software that is installed on one or more game player's chosen electronic device(s) before use. Once installed and initialized, the program executable for the game player can be launched which will run the game.

Once the game player app is installed and activated, the player can tap on the sliding side menu to access their contacts to initiate a head-to-head Texas Hold'em poker or other game) challenge. The player may choose from his/her existing app contacts or may import more contacts by selecting from his/her phone contact list, from his/her friends on social networks such as Facebook, or from the open challenge players list provided in the app (e.g., developed by the game provider or by other players or prospective players).

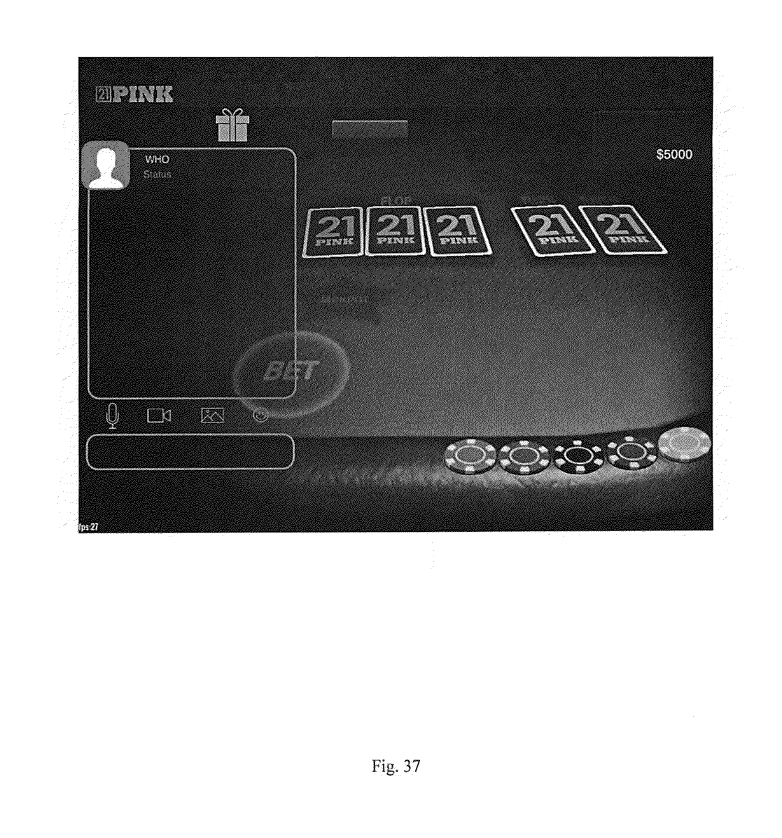

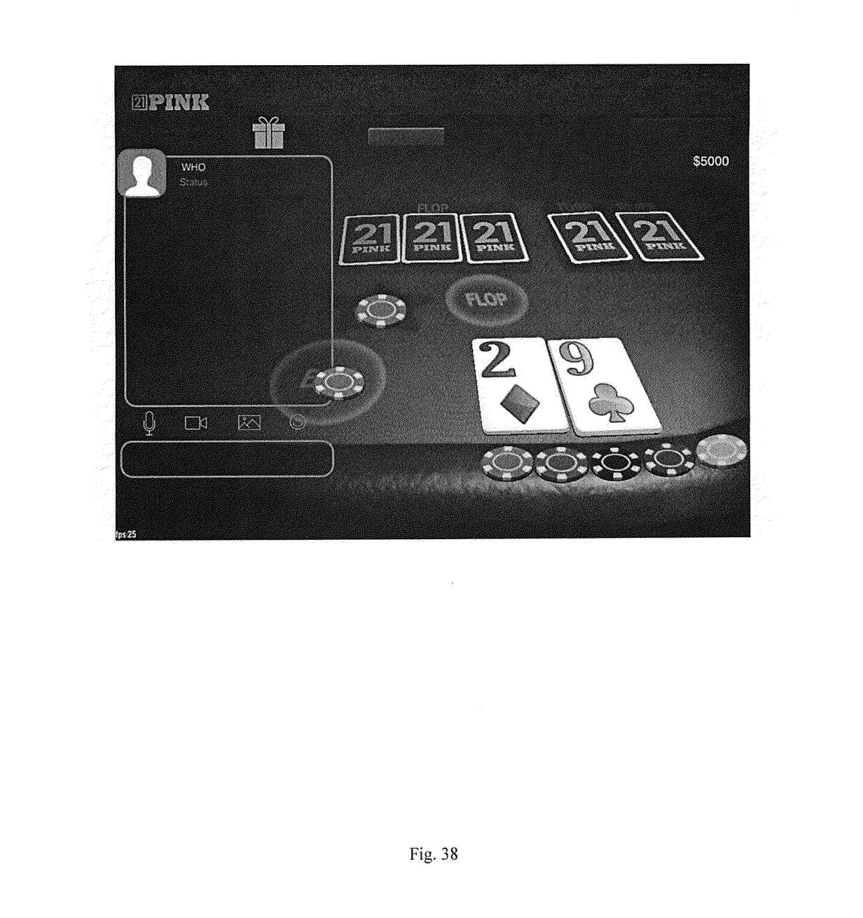

After a potential opponent is selected for a challenge or head-to-head game or match, the app will automatically send a notification to the opposing player's app, preferably via a push notification. If the receiving player accepts the challenge, the app will notify the game server that a game is ready to play. Next, the game server (e.g., hosted by the game provider) will notify and instruct the game system to deal five community cards face down, via a software based virtual dealer (e.g., optionally, a live dealer may be used), then deal two cards for the receiving player and two cards for the challenging player. See, e.g., FIG. 37. All player cards will be dealt face down. After cards have been dealt, the game server will send a notification and instruct the game system that both players will be given a specific time limit to place “blinds” bets. This time limit may preferably be represented by a graphical element to represent the remaining time left. Once the provided time has expired, and both players have placed bets, the game server will transmit and/or process data pertaining to the value and suit of the cards that each player has been dealt. The game system, using the game player app, will then produce a graphical representation of the playing cards as given by the game server. Each player will be able to view their own cards, and only their own cards, on the electronic device containing the game player app. See, e.g., FIG. 38.

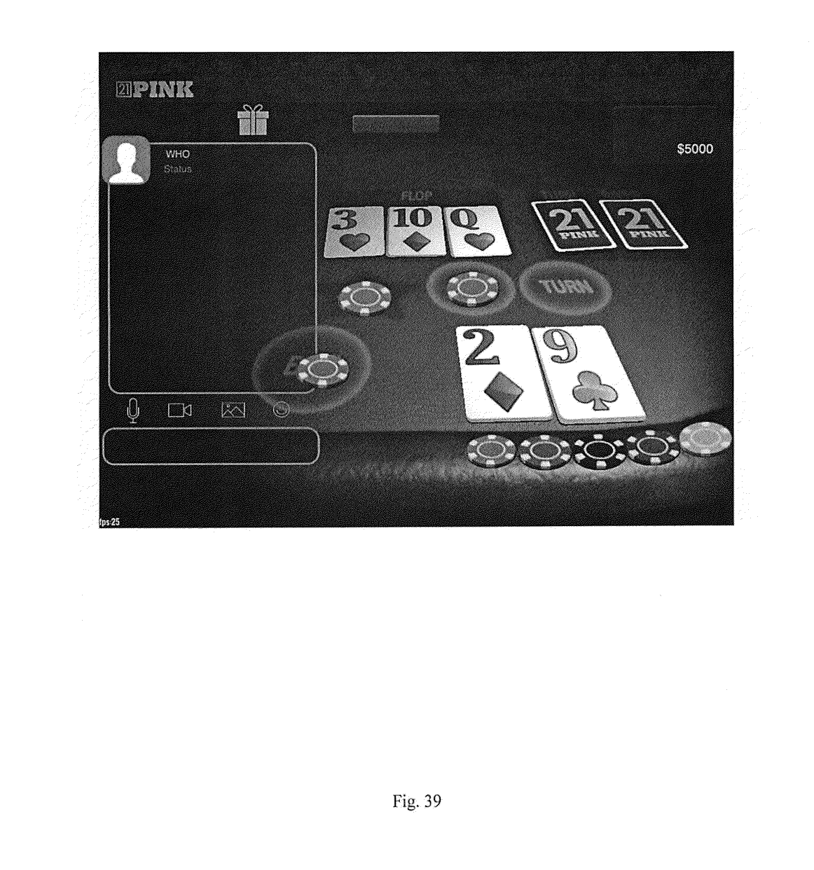

Next, the game server will send instructions to each game player app and a new timer will start, giving both players a specific amount of time to place a new bet for the “flop” (the act of flipping the first 3 community cards). This time limit will again preferably be represented by a graphical element to represent the remaining time left. Once the time has expired, and both players have placed bets, then the game server will instruct each player app to flip the first three community cards (virtually, via software) while also sending data to each player app pertaining to the value and suit of each card, so that each game player may be apprised of such card identification data. See, e.g., FIG. 39.

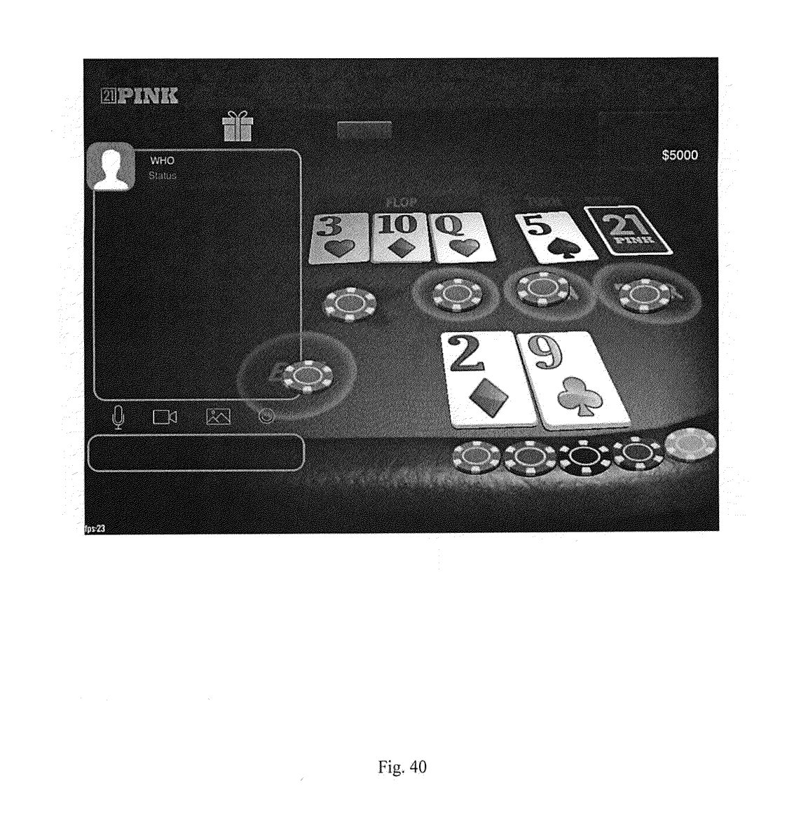

In the next game phase, the game server sends instructions to each player app and a new timer will start again giving both players a specific amount of time to place a new bet for the fourth community card, also known as the “turn” card. This time limit will again be represented by a graphical element to represent the remaining time left. Once the time has expired, and both players have placed bets, then the game server will transmit electronic instructions to each player app to flip the fourth community card while, again, sending data to each player app identifying the value of suit of the cards, so that such card identification information can and is shared with game players. See, e.g., FIG. 40.

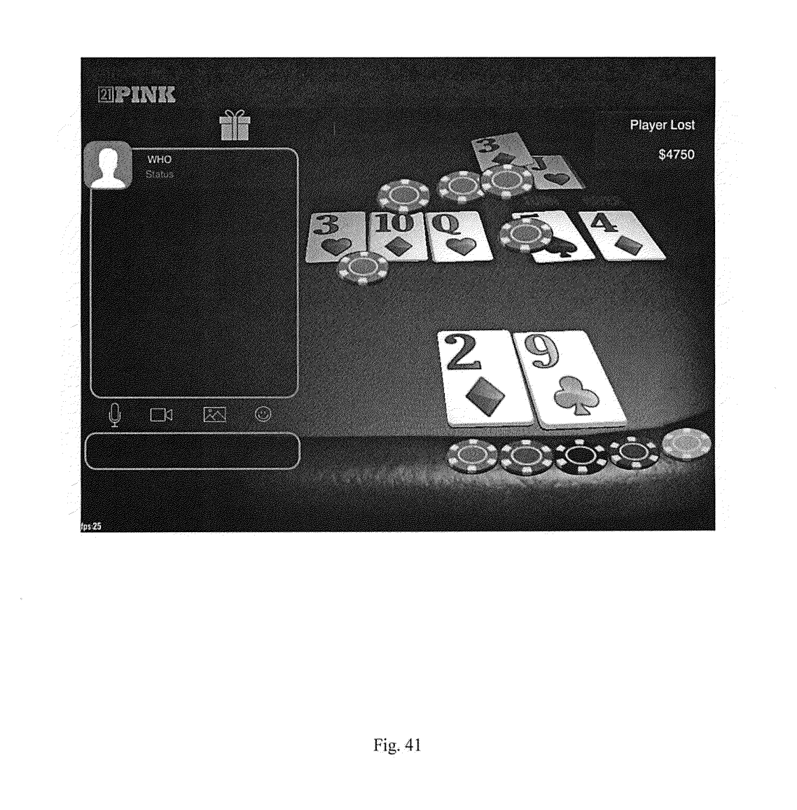

Next, the game server will again send instructions to each player app and a new timer will start again giving both players a specific amount of time to place a new bet for the fifth community card also known as the “river” card. This time limit will again be represented by a graphical element to represent the remaining time left. Once the time has expired, and both players have placed bets, then the game server will direct each player app (via transmission of electronic instructions) to flip the fifth community card while also transmitting data to each app pertaining to the identification of the value and suit of the dealt cards. See, e.g., FIG. 41. This information is then shared by the player apps, with the players, via display on the players' electronic devices.

Finally, in the next game phase, the game server sends instructions to each player app and a new timer will start again giving both players a specific amount of time to place a new bet—to call, raise, or fold for the final round of the game. This time limit will again be represented by a graphical element to represent the remaining time left. Once the time has expired, and both players have placed bets or made other possible decisions, then the game server will direct each player app to flip and reveal each player's cards to each the other player. Thereafter, the game server will score the game, and in this process thereby calculating and awarding virtual currency to the winner. Afterwards, the players have the option of starting a new game.

As with certain other example embodiments described herein, during the game, game players may (in optional embodiments) engage in chat or other communications with each other. This may occur in the form of text, audio, image, and/or video messaging. To enable this, a game player can tap on a chat button (e.g., as part of a graphical user interface implemented in a touch screen), thereafter compose a message, and then send the composed message to the other player who will receive the message within their game player app. The receiving player may respond by also tapping on a similar chat button, composing a reply message, and then sending the message back to the other player.

Non-Limiting Example of a Bingo Game:

In an alternative embodiment of the herein described inventive games, systems, and methods, one or more bingo games may be operated with one or more players participating in the game(s) from locations geographically remote from the game provider or game home base. The following is a “walk through” example of one embodiment of an invention involving the game of “bingo”. In this embodiment, game mechanics are delivered by software that is installed on a computer or computer server for operation by the game provider or dealer or moderator, with separate software components being installed on game players' chosen electronic devices (e.g., mobile phones, tablets, laptops, desk top computers, etc.). Once installed, both the program executable for the dealer/game moderator and the separate programs for the game players can be launched in order to run or operate the game. When broadcast live, such as in preferred embodiments, the live broadcast cameras are activated so that the actions of the dealer/game moderator may be broadcast, such as via television signal, to an audience. Also, at the beginning of a game, the dealer/moderator will be presented with an interface prompting the dealer/moderator to start the game and to start a timer to allow game players a specific amount of time to purchase bingo cards to participate in the game.

The game players, upon launching a player software app on their chosen electronic device, will be notified that a new game is starting (e.g., via an interface which is part of the app or via external methods such as SMS or MMS messaging) and then, in preferred embodiments, are prompted to buy bingo cards in order to participate in the game within the specified amount of time. In some embodiments, a visible timer is presented to indicate the amount of time left to purchase bingo cards to participate in the current game. Once the time has expired, the game player app will send a notification to the dealer program about all of the players who purchased a bingo card before the time limit was up. The dealer program will send a notification to those game players who did not make a bet in time, in certain (but not all) embodiments, notifying them that they are not in this current game. All others will continue to participate in the game.

Once time has expired (i.e., the participation deadline has passed), the dealer will start drawing balls or chips from a container. As each ball or chip is drawn, it is scanned using a scanner or detector (e.g., to scan bar codes or “OCR” data or to detect RFID or similar devices) so that identifying information may be collected and then such identification information broadcast to all participating game player devices apps. The game player may mark (also known as “daubing”) all of the purchased bingo cards that contain information matching the drawn ball or chip (e.g., such as a matching number). This may be done, in some (but not all) embodiments, electronically so that such information may be automatically read or transmitted to the game provider, dealer, or moderator (optionally, non-automatic conventional bingo cards and marking may be used). If a game player notices that they have enough marks on their card to complete a row of 5 number spots either horizontally, vertically, or diagonally, that game player may hit the “bingo” button to notify the dealer program (other values or sequences may, of course, be used in the rules of the game). The first game player to hit the “bingo” button and be confirmed by the dealer will win the bingo game. The dealer will continue to draw balls or chips until a winner is found. Once a winner is found, the winner results are broadcast to all game player devices through the software app and another bingo game is started using the same pattern as described above.

In certain embodiments of the described game, similar to other embodiments described herein, game players may engage in chat or other communications with the dealer during the game. This may be accomplished using software components that allow transmission of text, audio, images, and/or video. To enable such chat or other communications, the game player can tap on a chat button type, compose a message, and then send the composed message to the dealer who will receive the message in his/her dealer station. The dealer may also communicate with the players and, for example, may respond by also tapping on a chat message button and sending a composed message back to the game player that originated the communication. Similar chat or communication functionalities may be provided among players. Additionally, during a bingo game, game players may send tips in the form of virtual gifts to the bingo moderator or dealer. To do so, the game player can tap on a provided gift button (e.g., generated by a software app installed on the game players electronic device) which will slide open (or otherwise open) a gift menu. Tapping on any one of these gifts, in this optional embodiment, will automatically send the selected gift to the dealer.

Once given the above disclosure, many other features, modifications, and improvements will become apparent to the skilled artisan. Such features, modifications, and improvements are therefore considered to be part of this invention, without limitation imposed by the example embodiments described herein. Moreover, any word, term, phrase, feature, example, embodiment, or part or combination thereof, as used to describe or exemplify embodiments herein, unless unequivocally set forth as expressly uniquely defined or otherwise unequivocally set forth as limiting, is not intended to impart a narrowing scope to the invention in contravention of the ordinary meaning of the claim terms by which the scope of the patent property rights shall otherwise be determined:

We claim:

1. A system for providing game play, utilizing playing cards, comprising:
a playing card dealer table outfitted or associated with one or more scanner or detector devices capable of scanning or detecting the rank and suit of playing cards dealt by a playing card dealer;
one or more game player display screens configured for displaying game play data and information, said one or more game player display screens being located geographically remote from said playing card dealer table;
one or more game player data input devices configured to permit one or more game players to input instructions, in the form of transmittable data,
corresponding to game play decisions or actions, for transmission to said playing card dealer table or a processor or database associated with said playing card dealer table or to a game operator, said one or more game player data input devices being located geographically remote from said playing card dealer table;
an image or video capturing device for capturing images or video of said playing card dealer table and a playing card dealer, said image or video capturing device further being configured for transmitting image or video data collected to said one or more game player display screens;
a bi-directional network communicably connecting said player card dealer table, said one or more game player display screens, said one or more game player data input devices, and said image or video capturing device; said bi-directional network being configured to deliver or transmit data generated or transmitted by one or more game players, utilizing said one or more game player data input devices, or generated or transmitted by said playing card dealer table, or generated or transmitted by said one or more scanners or detector devices outfitted on or associated with said playing card dealer table, or generated or transmitted by said image or video capturing device;
a game processor including a computer readable medium in communication with a computer processor; said computer readable medium and said computer processor being communicably connected to said bi-directional network; said computer readable medium including, stored thereon, a set of computer readable and executable instructions for processing by said computer processor, said computer readable and executable instructions being defined to control the parameters of playing card game play and being defined to direct data traffic on said bi-directional network, said data traffic resulting from data generated or transmitted by one or more game players, utilizing said one or more game player data input devices, or generated or transmitted by said playing card dealer table, or generated or transmitted by said one or more scanners or detector devices outfitted on or associated with said playing card dealer table, or generated or transmitted by said image or video capturing device, in conjunction with game play decisions or actions occurring during said playing card game play.

2. The system according to claim 1 further including playing cards marked with bar codes including data corresponding to rank and suit of said marked cards and wherein said scanner outfitted or associated with said playing card dealer table is a bar code scanner; and
wherein said system is so configured such that said barcodes of playing cards dealt by a dealer are scanned by said bar code scanner, thereby to determine rank and suit of such dealt cards.

3. The system according to claim 1 further including playing cards which include radio frequency identification devices, said radio frequency identification devices including data corresponding to rank and suit of said playing cards and wherein said detector outfitted or associated with said playing card dealer table is a radio frequency identification device detector; and
wherein said system is so configured such that said radio frequency identification devices of playing cards dealt by a dealer are detected by said radio frequency identification device detector, thereby to determine rank and suit of such dealt cards.

4. The system according to claim 2 wherein rank and suit information of dealt cards, determined by said scanner, is transmitted by said bi-directional network to said one or more game player display screens; and
wherein said rank and suit information is analyzed by said game processor, in accordance with a set of game rules defined by said computer readable and executable instructions, to determine an impact of dealt playing cards on a result of a game being played with said playing cards.

5. The system according to claim 3 wherein rank and suit information of dealt cards, determined by said detector, is transmitted by said bi-directional network to said one or more game player display screens; and
wherein said rank and suit information is analyzed by said game processor, in accordance with a set of game rules defined by said computer readable and executable instructions, to determine an impact of dealt playing cards on a result of a game being played with said playing cards.

6. The system according to claim 4 wherein said one or more game player data input devices is configured to permit one or more game players to input wager information to wager on a game being played with said playing cards, said system being configured such that said game processor receives said wager information so that said game processor can calculate wager wins and losses and distribute game winnings to game players, in accordance with game rules defined by said computer readable and executable instructions.

7. The system according to claim 5 wherein said one or more game player data input devices is configured to permit one or more game players to input wager information to wager on a game being played with said playing cards, said system being configured such that said game processor receives said wager information so that said game processor can calculate wager wins and losses and distribute game winnings to game players, in accordance with game rules defined by said computer readable and executable instructions.

8. The system according to claim 6 further including a plurality of playing card location detectors configured to determine the location or other attribute of a dealt card placed on said playing card dealer table.

9. The system according to claim 7 further including a plurality of playing card location detectors configured to determine the location or other attribute of a dealt card placed on said playing card dealer table.

10. The system according to claim 8 wherein said playing card location detectors detect information sufficient determine which player a dealt card is associated with or which card hand a card is associated with or whether a dealt card is associated with a dealer hand.

11. The system according to claim 9 wherein said playing card location detectors detect information sufficient determine which player a dealt card is associated with or which card hand a card is associated with or whether a dealt card is associated with a dealer hand.

12. The system according to claim 10 wherein said playing card location detectors transmit information detected or collected related to which player a dealt card is associated with, which card hand a card is associated with, or whether a dealt card is associated with a dealer hand, via said bi-directional network for display on said one or more game player display screens.

13. The system according to claim 11 wherein said playing card location detectors transmit information detected or collected related to which player a dealt card is associated with, which card hand a card is associated with, or whether a dealt card is associated with a dealer hand, via said bi-directional network for display on said one or more game player display screens.

14. The system according to claim 12 further including win/loss rules defined by said computer readable and executable instructions, said win/loss rules being applied by said game processor to determine winners and losers of a playing card game, and said win/loss rules being applied to distribute or apportion winning wagers to players via electronic financial distributions or notations transmitted via said bi-directional network to player accounts, or to intake funds at stake in lost wagers.

15. The system according to claim 13 further including win/loss rules defined by said computer readable and executable instructions, said win/loss rules being applied by said game processor to determine winners and losers of a playing card game, and said win/loss rules being applied to distribute or apportion winning wagers to players via electronic financial distributions or notations transmitted via said bi-directional network to player accounts, or to intake funds at stake in lost wagers.

16. The system according to claim 1 wherein said computer readable and executable instructions include instructions defining a playing card game comprising the following rules wherein:
participating playing card game players place an opening ante wager in a designated location on said playing card dealer table;
participating playing card game players optionally placing a progressive jackpot wager by placing a wager of a specified financial amount into a second designated location proximal said ante wager;
participating playing card game players are dealt two playing cards on said playing card dealer table face-up, termed hole cards;
after dealing said hole cards to the participating playing card game players, a dealer's hand is dealt on said playing card dealer table comprising two playing cards face-up;
after said dealer's hand is dealt, participating playing card game players can choose a subsequent game play selected from the group consisting of: i) conceding and surrender said ante wager and ii) placing a first additional wager in a third designated location on said playing card dealer table, said additional wager being twice the value of said ante wager;
after said subsequent game play is completed, three additional playing cards are dealt on said playing card dealer table face-up as community cards;
after said three community cards are dealt, participating playing card game players can choose a subsequent game play selected from the group consisting of: iii) placing a second additional wager, said second additional wager being equal in value to said ante wager and iv) continuing game play without placing an additional wager;
after all participating playing card game players have completed game play steps iii) or iv), a fourth community card is dealt face-up on said playing card dealer table;
after said fourth community card is dealt, participating playing card game players can choose a subsequent game play selected from the group consisting of: v) placing a third optional wager, said second additional wager being equal in value to said ante wager and vi) continuing game play without placing an additional wager;
after all participating playing card game players have completed game play steps v) or vi), a fifth community card is dealt face-up on said playing card dealer table;
after said fifth community card is dealt, dealt hole cards of the participating playing card game players and dealt cards of said dealer's hand are separately compared to said five community playing cards, whereby a) each said two hole card set of the participating playing card game players is combined with three of said five community playing cards to obtain a best combination of rank and suits, termed said best player hand, as determined by poker rules; b) said two playing cards of said dealer's hand are combined with three of said five community playing cards to obtain a best combination of rank and suits, termed said best dealer hand, as determined by poker rules; and
wherein said best player hands of the participating playing card game players are compared to the best dealer hand, and winning hands are determined according to a comparison of rank and value of best player hands as compared to the best dealer hand.

17. The system according to claim 14 wherein said computer readable and executable instructions include instructions defining a playing card game comprising the following rules wherein:
participating playing card game players place an opening ante wager in a designated location on said playing card dealer table;
participating playing card game players optionally placing a progressive jackpot wager by placing a wager of a specified financial amount into a second designated location proximal said ante wager;
participating playing card game players are dealt two playing cards on said playing card dealer table face-up, termed hole cards;
after dealing said hole cards to the participating playing card game players, a dealer's hand is dealt on said playing card dealer table comprising two playing cards face-up;
after said dealer's hand is dealt, participating playing card game players can choose a subsequent game play selected from the group consisting of: i) conceding and surrender said ante wager and ii) placing a first additional wager in a third designated location on said playing card dealer table, said additional wager being twice the value of said ante wager;
after said subsequent game play is completed, three additional playing cards are dealt on said playing card dealer table face-up as community cards;
after said three community cards are dealt, participating playing card game players can choose a subsequent game play selected from the group consisting of: iii) placing a second additional wager, said second additional wager being equal in value to said ante wager and iv) continuing game play without placing an additional wager;
after all participating playing card game players have completed game play steps iii) or iv), a fourth community card is dealt face-up on said playing card dealer table;
after said fourth community card is dealt, participating playing card game players can choose a subsequent game play selected from the group consisting of: v) placing a third optional wager, said second additional wager being equal in value to said ante wager and vi) continuing game play without placing an additional wager;
after all participating playing card game players have completed game play steps v) or vi), a fifth community card is dealt face-up on said playing card dealer table;
after said fifth community card is dealt, dealt hole cards of the participating playing card game players and dealt cards of said dealer's hand are separately compared to said five community playing cards, whereby a) each said two hole card set of the participating playing card game players is combined with three of said five community playing cards to obtain a best combination of rank and suits, termed said best player hand, as determined by poker rules; b) said two playing cards of said dealer's hand are combined with three of said five community playing cards to obtain a best combination of rank and suits, termed said best dealer hand, as determined by poker rules; and
wherein said best player hands of the participating playing card game players are compared to the best dealer hand, and winning hands are determined according to a comparison of rank and value of best player hands as compared to the best dealer hand.

18. The system according to claim 15 wherein said computer readable and executable instructions include instructions defining a playing card game comprising the following rules wherein:
participating playing card game players place an opening ante wager in a designated location on said playing card dealer table;
participating playing card game players optionally placing a progressive jackpot wager by placing a wager of a specified financial amount into a second designated location proximal said ante wager;
participating playing card game players are dealt two playing cards on said playing card dealer table face-up, termed hole cards;
after dealing said hole cards to the participating playing card game players, a dealer's hand is dealt on said playing card dealer table comprising two playing cards face-up;
after said dealer's hand is dealt, participating playing card game players can choose a subsequent game play selected from the group consisting of: i) conceding and surrender said ante wager and ii) placing a first additional wager in a third designated location on said playing card dealer table, said additional wager being twice the value of said ante wager;
after said subsequent game play is completed, three additional playing cards are dealt on said playing card dealer table face-up as community cards;
after said three community cards are dealt, participating playing card game players can choose a subsequent game play selected from the group consisting of: iii) placing a second additional wager, said second additional wager being equal in value to said ante wager and iv) continuing game play without placing an additional wager;
after all participating playing card game players have completed game play steps iii) or iv), a fourth community card is dealt face-up on said playing card dealer table;
after said fourth community card is dealt, participating playing card game players can choose a subsequent game play selected from the group consisting of: v) placing a third optional wager, said second additional wager being equal in value to said ante wager and vi) continuing game play without placing an additional wager;
after all participating playing card game players have completed game play steps v) or vi), a fifth community card is dealt face-up on said playing card dealer table;
after said fifth community card is dealt, dealt hole cards of the participating playing card game players and dealt cards of said dealer's hand are separately compared to said five community playing cards, whereby a) each said two hole card set of the participating playing card game players is combined with three of said five community playing cards to obtain a best combination of rank and suits, termed said best player hand, as determined by poker rules; b) said two playing cards of said dealer's hand are combined with three of said five community playing cards to obtain a best combination of rank and suits, termed said best dealer hand, as determined by poker rules; and
wherein said best player hands of the participating playing card game players are compared to the best dealer hand, and winning hands are determined according to a comparison of rank and value of best player hands as compared to the best dealer hand.
